(19) United States
(12) Patent Application Publication
(10) Pub. No.: US 2026/0320714 A1
(43) Pub. Date: Oct. 15, 2026

(54) SYSTEMS AND METHODS FOR POLICY-AWARE AI-DRIVEN ALLOCATION OF ASSET OWNERSHIP AND USAGE WITH TRANSACTION COMPRESSION, MULTILATERAL NETTING, AND AUDIT-GRADE RECEIPTS

(71) Applicant: Thomas Hecht, Cambridge, MA (US)

(72) Inventor: Thomas Hecht, Cambridge, MA (US)

(21) Appl. No.: 19/458,987

(22) Filed: Jan. 26, 2026

Related U.S. Application Data
(63) Continuation-in-part of application No. 19/051,264, filed on Feb. 12, 2025, now Pat. No. 12,561,745.

(51) Int. Cl. G06Q 50/18; G06N 3/0495; G06N 3/09

(52) U.S. Cl. CPC G06Q 50/18; G06N 3/0495; G06N 3/09

(57) ABSTRACT

A computing platform allocates ownership of an asset for maximized collective economic benefit while preserving user usage rights. The platform ingests asset-utilization transactions, user profiles, and supplemental datasets, and trains and executes an AI/ML categorization engine on a hardware accelerator using quantization and sparsity-preserving updates. The platform predicts a most-efficient-use vector, detects ownership inefficiency, selects a specialized ownership entity that maximizes expected benefit under policy constraints, and executes a retitling transaction comprising a conveyance plus a usage agreement. Optional embodiments generate audit-grade, hash-linked receipts and compress obligations via graph-based multilateral netting, geospatial shard migration, and intermediary internalization to reduce settlement legs, latency, and attack surface.

### CROSS-REFERENCE TO RELATED APPLICATIONS

This application is a continuation-in-part of U.S. patent application Ser. No. 19/051,264, filed Feb. 12, 2025, entitled “Artificial Intelligence Systems and Methods for Efficient Use of Assets,” published as U.S. Patent Application Publication No. US 2025/0182211 A1 on Jun. 5, 2025.

The entire contents of the foregoing application/publication are incorporated herein by reference for all purposes to the extent permitted by 37 C.F.R. § 1.57.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A SEQUENCE LISTING

Not applicable.

### INCORPORATION BY REFERENCE

The following U.S. patent application publications and applications, and any counterparts thereof, are incorporated by reference in their entireties for all purposes to the extent permitted under 37 C.F.R. § 1.57, including example data structures, workflows, and implementation details:
US 2016/0225081 A1
US 2021/0295432 A1
US 2023/0214920 A1
US 2024/0330865 A1
US 2025/0005638 A1
US 2025/0005670 A1
US 2025/0156959 A1
US 2025/0182211 A1

Incorporation by reference is intended to comply with 37 C.F.R. § 1.57. No essential material is incorporated by reference except as permitted by applicable rules, and any non-essential material is incorporated by reference to the extent permitted. To the extent there is any inconsistency between this specification and any incorporated reference, the present specification controls.

The background discussion is provided for context and does not constitute an admission that any referenced material is prior art. Applicant disclaims any admission that subject matter characterized as “conventional,” “known,” or “existing” constitutes prior art as to any claim.

### FIELD OF THE INVENTION

The present disclosure relates to computer-implemented systems and methods for efficient allocation of asset ownership and usage, including systems that (i) use machine learning (ML) to predict efficient use configurations, (ii) decouple legal ownership from usage rights, (iii) compress or eliminate redundant transactions via netting and atomic execution across settlement rails, and (iv) generate cryptographically verifiable receipts for auditability, governance, and policy compliance.

More particularly, embodiments describe computer-implemented architectures that improve the operation of distributed computing platforms by: (i) compressing and accelerating machine-learning inference and training (e.g., quantization and sparsity-preserving updates executed on an ASIC), (ii) compressing obligation and settlement graphs via policy-constrained multilateral netting and intermediary internalization, (iii) reducing interaction-surface area and attack surface by consolidating and eliminating redundant transactional steps, and (iv) enabling deterministic, audit-grade replay using cryptographically bound receipts, correlation identifiers, and tamper-evident checkpoints.

### BACKGROUND OF THE INVENTION

Enterprises and households operate across heterogeneous platforms for payroll, benefits administration, banking, broker-dealers, insurance, accounting, procurement, and marketplaces. Each platform often maintains duplicative records, inconsistent timing conventions, and separate reconciliation processes. Many workflows also depend on intermediaries (e.g., brokers, agents, lenders, managers, and other middlemen) to reconcile obligations, enforce policy constraints, and coordinate timing. This fragmentation increases transaction volume, reconciliation load, and latency, and can prevent participants from capturing available economic value.

Certain economically meaningful assets or entitlements are difficult or impossible to transfer, not because they lack value, but because rules constrain how they can be used. Examples include benefits and plan-bound entitlements such as employee stock purchase plans (ESPP), employer retirement plan matches, health plan affordability and eligibility constraints, and other regulated or plan-scoped rights. These constraints are often intended to protect participants, but they can also create barriers that block efficient allocation of resources.

Point solutions exist for specific benefit-capture problems, such as “cashless” participation mechanics and advance/loan offerings intended to help employees capture matches or discounts. However, such approaches typically do not unify identity, policy constraints, eligibility proofs, and settlement across related obligations (e.g., payroll deductions, taxes, brokerage flows, premiums, and plan limits). They may also introduce new intermediaries and fee extraction.

From a computing perspective, intermediary-heavy workflows typically generate a large number of discrete messages, records, and reconciliation steps across heterogeneous systems. The resulting interaction surface increases network traffic, storage duplication, and opportunities for fraud, replay, and inconsistent state. Existing tools often lack a deterministic, cryptographically verifiable record of (i) what inputs were used, (ii) which policies were applied, (iii) which model version produced a prediction, and (iv) what machine actions were executed. These deficiencies can increase operational cost, reduce security, and prevent automation of cross-system optimization.

There remains a need for computing systems that (i) represent policy and legal constraints in machine-executable form, (ii) predict and optimize ownership and usage structures under those constraints, (iii) execute fewer transactions through compression and netting while preserving required auditability, and (iv) provide regulator-grade, machine-verifiable evidence of how a result was computed and executed.

### BRIEF SUMMARY OF THE INVENTION

In embodiments, a computing system receives information about a user and an asset (including tangible assets, intangible assets, entitlements, or capacity slices) used or to be used by the user. The system ingests asset-utilization transaction data and supplemental historical datasets, and executes an ML categorization engine to output a predicted most-efficient-use vector for the asset. The system compares the predicted vector to declared or observed usage and flags an ownership inefficiency above a threshold. The system queries an ownership-entity database, ranks candidate specialized entities, and selects an entity that maximizes an expected collective economic benefit function subject to constraints.

The system encodes and executes a transaction that transfers legal title to the selected entity while preserving usage rights for the user via a lease, rental, license, subscription, or other long-term usage agreement. Executed records are stored, and a benefit-sharing parameter may be computed to redistribute measured benefits. The system can repeat an evaluate-and-optimize loop and re-title an asset without interrupting user access.

To improve performance and security and compliance posture, embodiments include concrete computing mechanisms such as: (i) storing neural-network weights and activations as 32-bit floating-point variables and statically quantizing them to 8-bit integers to reduce storage footprint; (ii) executing the ML inference and training loop on an application-specific integrated circuit (ASIC) optimized for neural networks; (iii) applying a functionally invariant path (FIP) algorithm to update network weights while preserving learned behavior and increasing sparsity; and (iv) migrating dataset shards between geospatial data centers based on latency and cost heuristics to sustain parallel low-latency access.

Optional modules provide transaction compression and governance: multilateral netting of reciprocal obligations within a consented clearing group; cross-rail atomic execution; cryptographically signed Proof-of-Netting (PoN), Proof-of-Benefit (PoB), and Proof-of-Classification (PoC) receipts; a rulepack-and policy-lattice engine that compiles jurisdiction-specific constraints; and privacy/security controls including selective disclosure and verifiable credential inputs.

In some embodiments, the platform strengthens security by (i) moving execution into an attested compute environment, (ii) using a zero-trust execution membrane with short-lived capability tokens, (iii) encrypting sensitive payloads using envelope encryption with a hierarchical key schedule, and (iv) maintaining a redactable yet tamper-evident receipt ledger that records authorized redactions as governed events. These mechanisms provide improved integrity, confidentiality, and auditability for automated allocation and transaction compression workflows.

In some embodiments, the platform reduces bandwidth and storage consumption by compressing both (i) model artifacts and (ii) transaction evidence. Model compression can include static quantization, pruning, sparsity-inducing updates, low-rank factorization, or weight sharing. Evidence compression can include Merkle checkpointing, proof-carrying receipts (e.g., membership proofs, range proofs, and selective-disclosure proofs), and materiality predicates that limit persisted data to what is required to verify compliance and execution.

In some embodiments, the platform further improves computer functionality by emitting receipts in accordance with an explicitly defined receipt grammar that enforces idempotent, exactly-once execution of state transitions. Each state transition consumes a prior state receipt and produces a new state receipt that binds (via hashes, signatures, and execution identifiers) the validated policy set, the model version, the netting set (if any), and the resulting commands dispatched to external systems. Deterministic replay against the receipt ledger allows verification of correctness without relying on manual reconciliation.

Technical effects include, without limitation:
reduced memory bandwidth and storage footprint via quantization, sparsity, and hardware-accelerated inference;
reduced network calls and reconciliation overhead via graph-based netting, transaction compression, and idempotent execution;
reduced latency via geospatial shard migration, caching, and prefetching of anticipated data;
improved auditability and determinism via typed, hash-linked receipts and deterministic replay; and
improved security and privacy via reduced interaction surface, attested execution, and selective disclosure (including optional ZK predicates).

These technical effects are achieved while preserving user experience (usage continuity) during retitling and while complying with policy, tax, benefits, and other regulatory constraints encoded in a policy lattice.

### BRIEF DESCRIPTION OF THE DRAWINGS

The accompanying drawings, which are incorporated in and constitute a part of this specification, illustrate embodiments of the invention and, together with the description, serve to explain the principles of the invention. The drawings are illustrative and not limiting. The drawings are not necessarily to scale. In the drawings:

FIG. 1 illustrates an example system architecture for a policy-aware, AI-driven asset ownership allocation platform with receipt-based auditability.

FIG. 2 illustrates example data structures for assets, specialized ownership entities, conveyance records, and usage-right agreements, including container identifiers and policy hashes.

FIG. 3 illustrates an example time-fabric pipeline that maps events into multiple calendar labels and period anchors for deterministic replay.

FIG. 4 illustrates an example predict-then-net workflow that forms candidate netting sets from projected flows and authorizes execution.

FIG. 5 illustrates an example multilateral netting graph used to generate residual settlement vectors and Proof-of-Netting receipts.

FIG. 6 illustrates an example cross-rail atomic settlement sequence spanning a bank rail and a programmable token rail.

FIG. 7 illustrates an example receipt spine/event ledger that hash-links typed receipts and supports deterministic replay and stateless verification.

FIG. 8 illustrates an example ESPP/401(k) autopilot orchestration that consolidates payroll deductions, brokerage legs, and tax remittances into an atomic group.

FIG. 9 illustrates an example household coverage optimization and cross-employer coordination-of-benefits settlement.

FIG. 10 illustrates task-granular role toggling between W-2 and 1099 classification states with Proof-of-Classification receipts.

FIG. 11 illustrates an example dispersion of closing cycles and capacity booking manifests with period anchors.

FIG. 12 illustrates an example redactable ledger entry and redaction proof structure under quorum control.

FIG. 13 illustrates an AI governance control plane enforcing provenance, confidence gates, and human-in-the-loop overrides with governance receipts.

FIG. 14 illustrates an example surplus measurement and routing module that computes compression savings and allocates them under governance rules.

FIG. 15 illustrates an example intermediary internalization controller and zero-trust execution membrane that issues short-lived capability tokens, enforces policy-lattice gates, and triggers transitions from external-intermediary execution to internal platform execution.

FIG. 16 illustrates an example attested-compute flow and edge device enforcing usage rights, including a trusted execution environment (TEE), remote attestation evidence, capability leases, and local receipts that synchronize to a receipt ledger.

### DETAILED DESCRIPTION

Reference will now be made in detail to illustrative embodiments of the invention, examples of which are illustrated in the accompanying drawings. In the following description, numerous specific details are set forth to provide a thorough understanding of the disclosed embodiments. However, it will be apparent to one skilled in the art that embodiments may be practiced without these specific details. In other instances, well-known structures and devices are shown in block diagram form to avoid unnecessarily obscuring the embodiments.

### A. DETAILED DESCRIPTION OF THE DRAWINGS

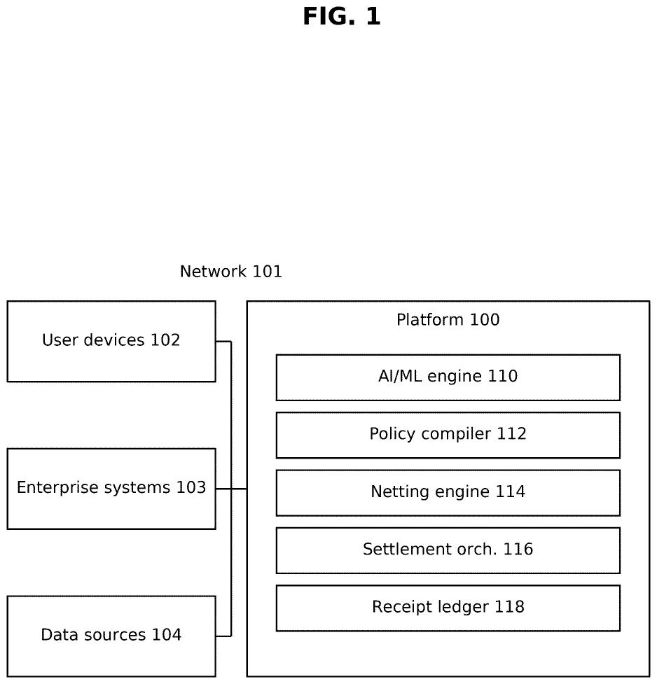

FIG. 1 shows a system architecture including a computing platform 100 coupled via a network 101 to user devices 102, enterprise/partner systems 103 (e.g., payroll, benefits, lending, brokerage, insurance, and marketplace systems), and data sources 104. The platform 100 includes an AI/ML categorization and optimization engine 110, a policy-and-constraint compiler 112, a transaction-compression and netting engine 114, a settlement orchestrator 116, and a receipt ledger 118 storing typed, hash-linked receipts used for deterministic replay and audit.

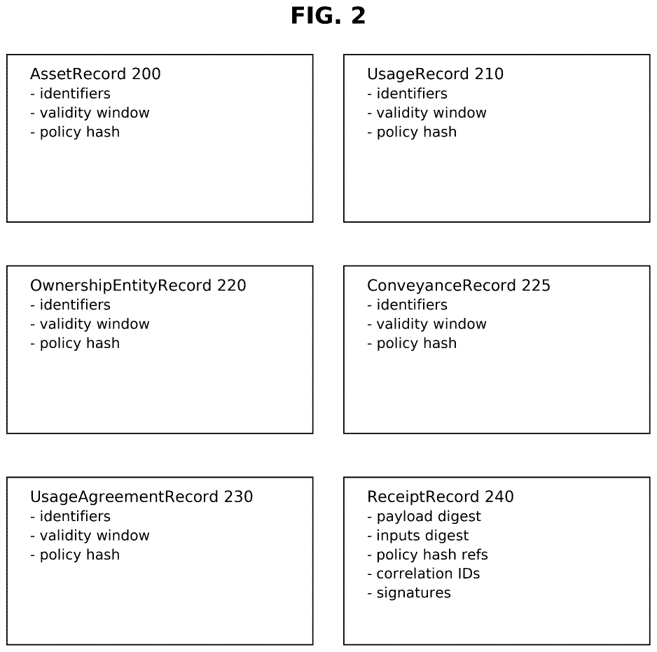

FIG. 2 shows example data structures including an AssetRecord 200, a UsageRecord 210, an OwnershipEntityRecord 220, a ConveyanceRecord 225, and a UsageAgreementRecord 230, each bound to identifiers, validity windows, and policy hashes; and a ReceiptRecord 240 comprising a payload digest, inputs digest, policy hash references, correlation identifiers, and signatures for verifiable audit.

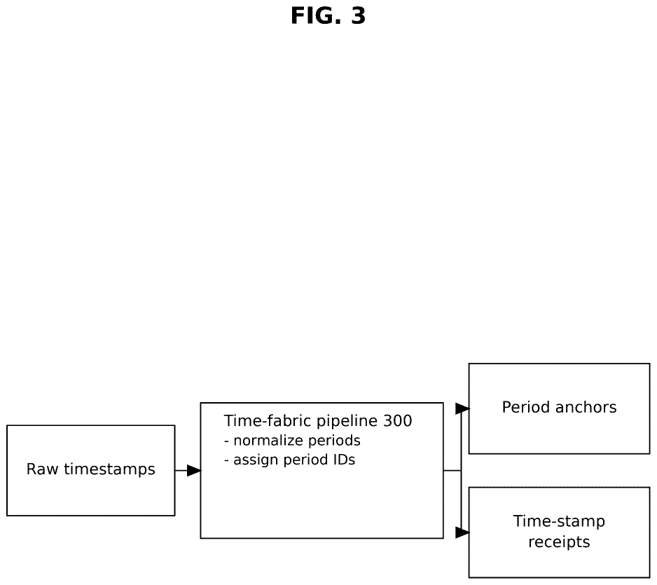

FIG. 3 shows a time-fabric pipeline 300 that ingests raw timestamps and assigns normalized period identifiers (e.g., pay-cycle IDs, accounting calendar IDs, and jurisdictional effective-date scopes), producing period anchors and time-stamp receipts for cross-module coordination.

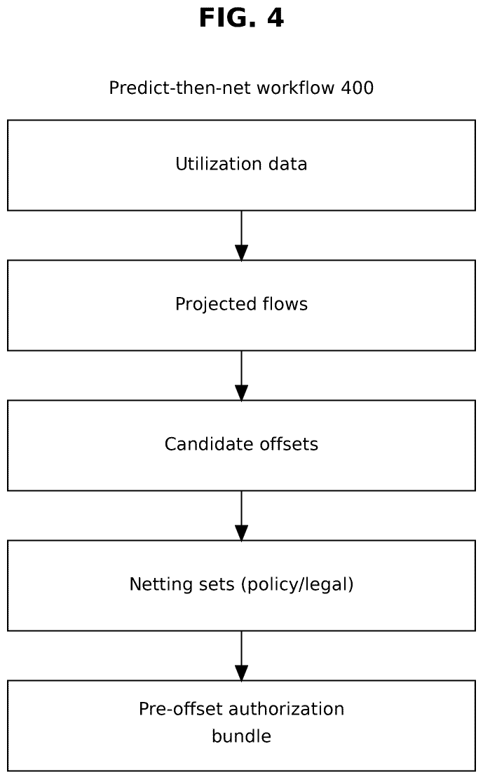

FIG. 4 shows a predict-then-net workflow 400 in which projected flows are generated from utilization data, candidate offsets are formed into netting sets under legality and policy constraints, and a pre-offset authorization bundle is emitted for atomic execution.

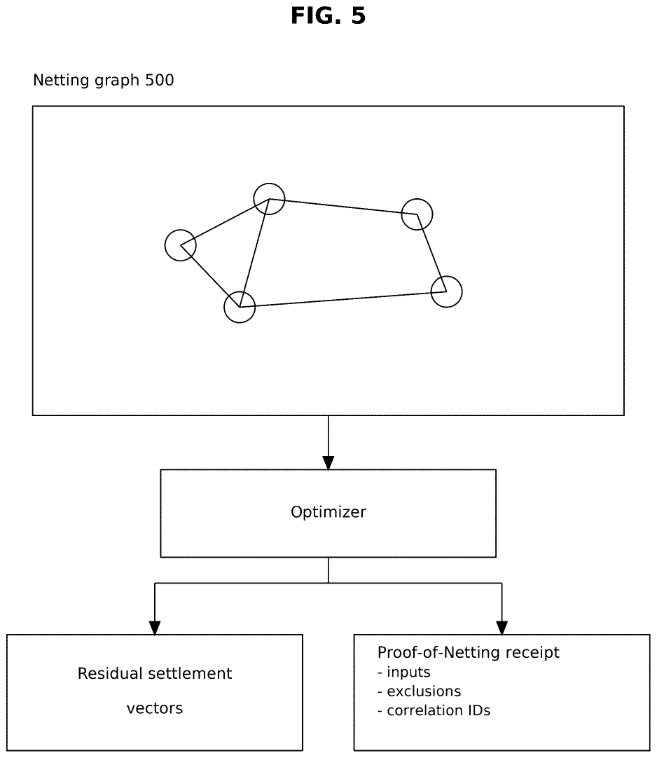

FIG. 5 shows a multilateral netting graph 500 in which obligations are represented as nodes and offset-eligible relationships as edges; an optimizer selects an admissible subgraph to produce residual settlement vectors and a Proof-of-Netting receipt binding inputs, exclusions, and correlation IDs.

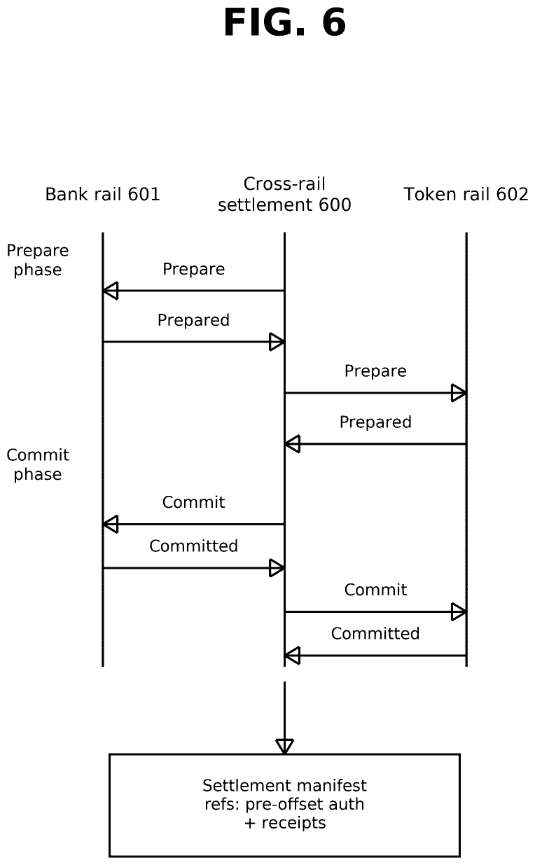

FIG. 6 shows a cross-rail atomic settlement sequence 600 coordinating a bank rail 601 (e.g., ACH/wire) and a programmable/token rail 602 under a two-phase commit or equivalent atomic protocol, producing a settlement manifest that references the pre-offset authorization and associated receipts.

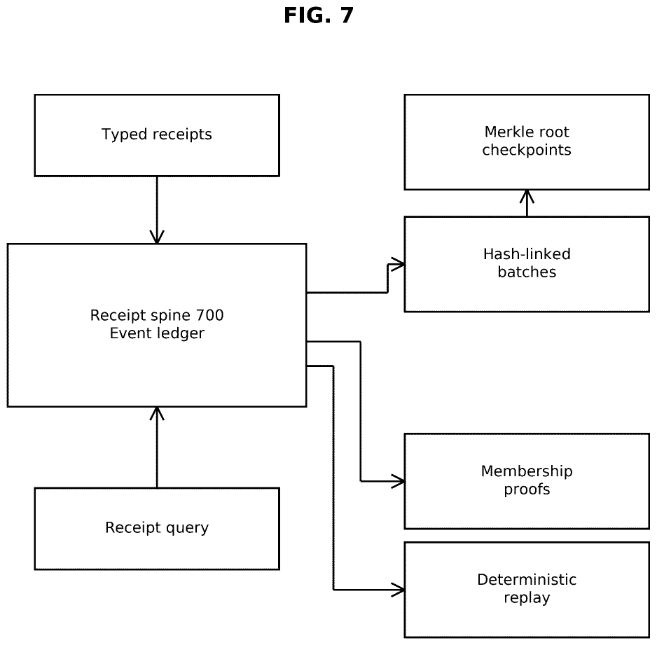

FIG. 7 shows a receipt spine 700 in which typed receipts are appended to an event ledger, hash-linked into batches, and checkpointed by Merkle roots; receipt queries return membership proofs and deterministic replay artifacts for audit, dispute resolution, and compliance reporting.

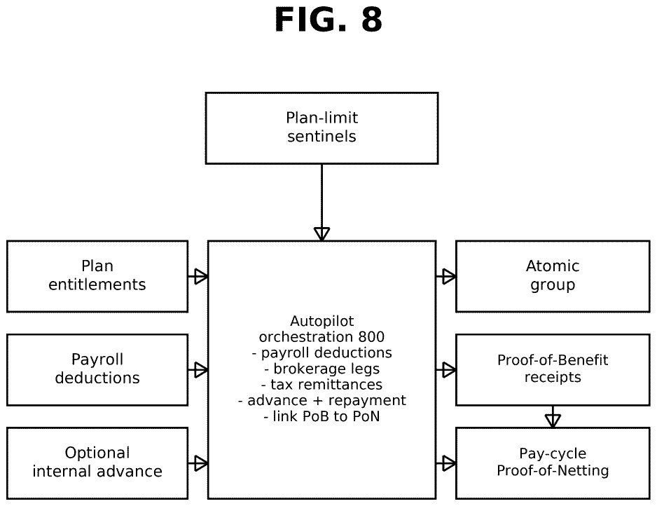

FIG. 8 shows an ESPP/401(k) autopilot orchestration 800 in which plan entitlements, payroll deductions, optional internal advances, sell-to-cover legs, and repayment legs are consolidated into an atomic group, with plan-limit sentinels and Proof-of-Benefit receipts linked to a pay-cycle Proof-of-Netting.

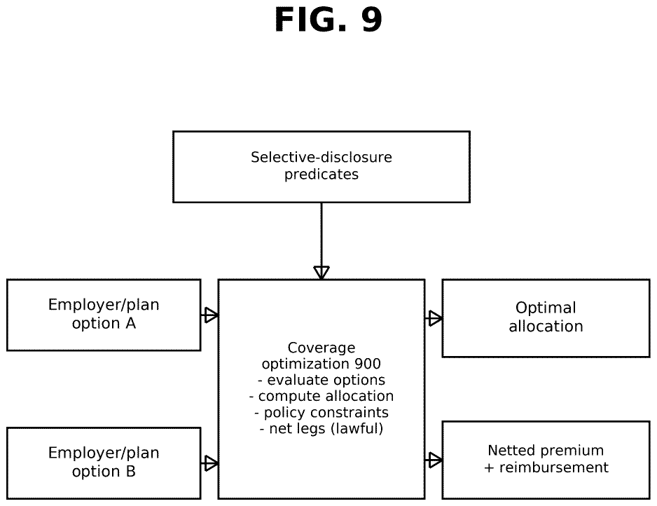

FIG. 9 shows a household coverage optimization 900 that evaluates available coverage options across multiple employers or plans using selective-disclosure predicates, computes an optimal allocation under policy constraints, and nets premium and reimbursement legs where lawful.

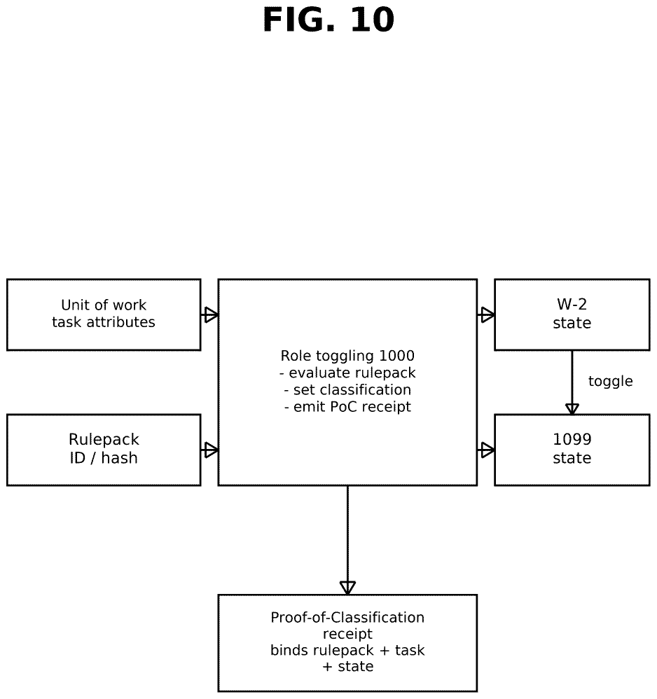

FIG. 10 shows task-granular role toggling 1000 between W-2 and 1099 classifications using rulepacks and Proof-of-Classification receipts that bind a rulepack identifier/hash, task attributes, and the resulting classification state for a time parcel or unit of work.

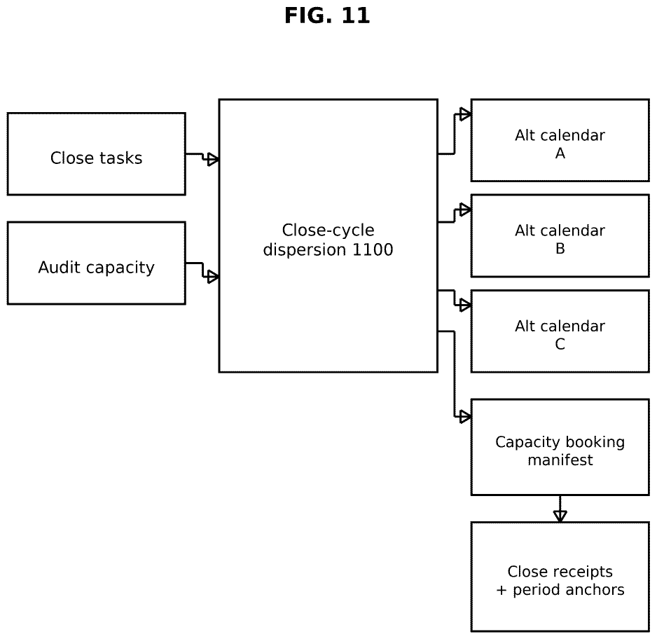

FIG. 11 shows dispersion of closing cycles 1100 in which accounting close tasks and audit capacity are scheduled across alternative calendars to reduce bottlenecks, and capacity booking manifests and close receipts are issued with period anchors.

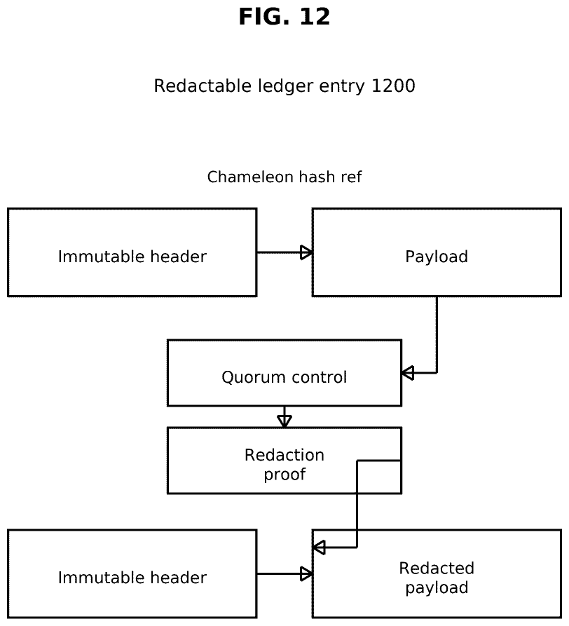

FIG. 12 shows a redactable ledger entry 1200 in which an immutable header references a payload via a chameleon hash, and a governed redaction process produces a redaction proof under quorum control while preserving auditability.

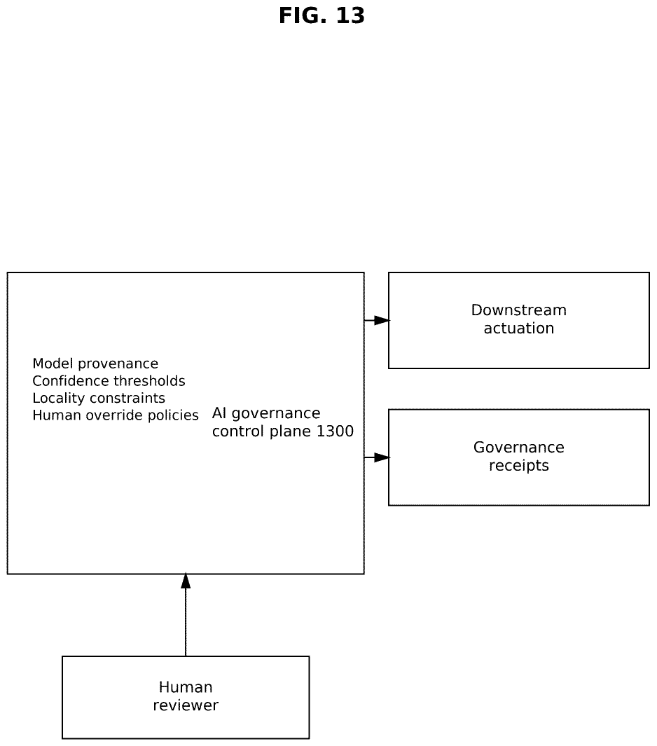

FIG. 13 shows an AI governance control plane 1300 that enforces model provenance, confidence thresholds, locality constraints, and human-in-the-loop override policies, and emits governance receipts bound to downstream actuation decisions.

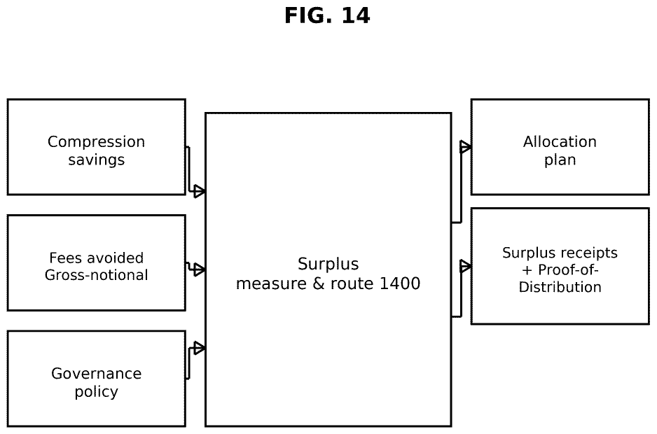

FIG. 14 shows a surplus measurement and routing module 1400 that quantifies savings created by transaction compression (e.g., fees avoided and gross-notional reduction), computes allocations under a governance policy, and issues surplus receipts and Proof-of-Distribution artifacts.

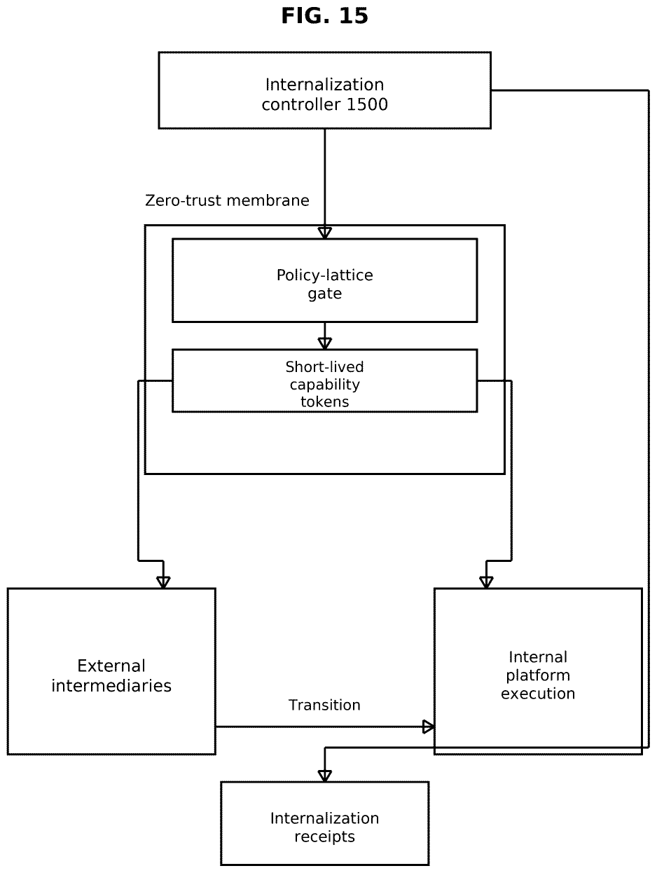

FIG. 15 shows an intermediary internalization controller 1500 and zero-trust execution membrane that gates actuation via policy checks, transitions eligible flows from external intermediaries to internal platform execution, and records internalization decisions and outcomes in receipts.

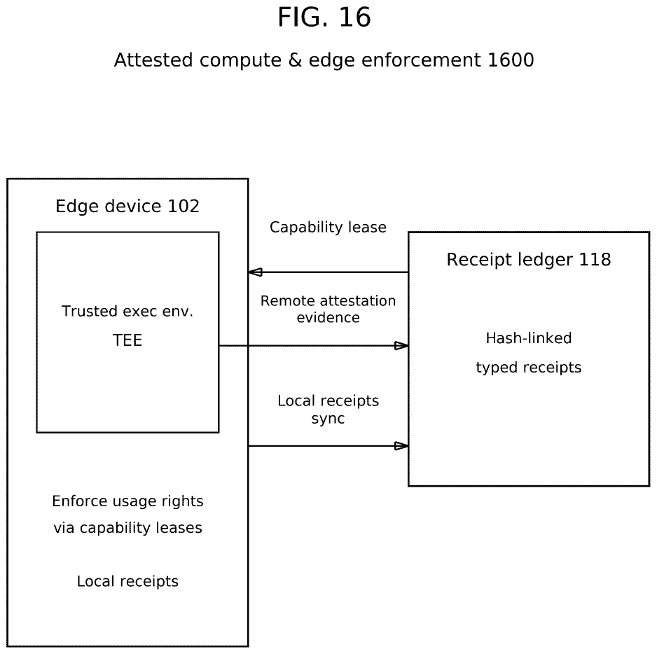

FIG. 16 shows an attested-compute and edge enforcement embodiment 1600 in which a trusted execution environment performs constrained computations, produces remote attestation evidence, enforces usage rights via capability leases, and synchronizes local receipts to the receipt ledger.

Reference numerals are provided for convenience and may be varied without departing from the scope of the invention.

### 1. Overview: Repeatable Kernel for Scalable Allocation and Compression

Across embodiments and verticals, a repeatable kernel is implemented as a computer-executed control loop that:
Ingests: captures state about (i) an asset/right/capacity, (ii) a participant/household, and (iii) a policy/law context (jurisdiction, plan rules, eligibility).• Represents: normalizes the state into structured objects (containers, graphs, typed receipts) with explicit version/hash binding.• Predicts: uses AI/ML to infer an efficient-use vector and detect inefficiency thresholds.• Optimizes: selects an ownership/structure/settlement configuration maximizing an objective function subject to compiled constraints.• Executes with compression: performs re-titling while preserving usage; replaces gross flows with net settlement vectors; groups multi-leg execution atomically.• Proves: emits receipt chains enabling deterministic replay and stateless verification.• Measures and allocates surplus: quantifies efficiency gains (fees avoided, retries avoided, utilization gains) and routes the gains under governance.• Learns safely: updates models under stability and governance gates, preserving prior learned behavior.

### 2. Terminology and Definitions

Unless the context indicates otherwise, the following terms are used throughout this disclosure. These definitions are illustrative and not limiting.
Asset: Any physical or intangible resource, entitlement, or capacity slice that can be used, consumed, accessed, or otherwise utilized by a participant. Assets include, without limitation: real property, vehicles, equipment, software licenses, accounts, contract rights, receivables, insurance entitlements, retirement-plan or benefits-plan entitlements, equity-plan participation rights, time/skill capacity, compute capacity, and any usage-restricted asset whose ownership and/or usage is constrained by policy or law.
User/Participant: A natural person or entity that uses an asset or participates in a clearing or optimization group. A participant may be identified by an account identifier or decentralized identifier (DID) and may present verifiable credentials.
Specialized Ownership Entity: An entity selected or instantiated to own an asset for purposes of maximizing an objective function, such as collective economic benefit, including, by non-limiting example, a special-purpose vehicle (SPV), trust, nonprofit entity, employer-of-record, pooled vehicle, partnership, or other wrapper with favorable tax, liability, governance, or regulatory characteristics.
Usage Rights/Usage Agreement: A data record and/or legal instrument granting the user possession, access, or other usage rights with respect to an asset, including leases, rentals, licenses, subscriptions, long-term usage agreements, or other access-preserving arrangements.
Rulepack (Rule-Pack): A versioned, jurisdiction-specific bundle of legal tests, factors, and thresholds used to classify resources or enforce policy constraints. A rulepack is identified by a rulepack identifier and a version or hash, allowing the system to bind decisions to the precise rules applied at the time of the decision.
Unit of Work: A smallest compensable work element (also referred to as a taskoid in some implementations) with a unique work identifier and descriptor (time, scope, role, jurisdiction).
Multilateral Netting: An optimization that offsets reciprocal obligations across a consented clearing group to minimize gross settlements, subject to legal set-off constraints. Multilateral netting may produce a single net payable/receivable per participant per cycle.
Pay Cycle/Period: A discrete settlement period used for aggregation, netting, and receipts, identified by a period identifier (period_id).
Settlement Identifier: A per-cycle reference that deterministically links settlement legs and receipts and can be carried through payment-rail messages as correlation identifiers.
Receipt: A structured, typed, digitally signed artifact that records inputs, outputs, and control coverage for a decision or execution step. Receipts are hash-linked in an append-only ledger to enable deterministic replay and stateless verification.
Proof-of-Classification (PoC): A receipt documenting a classification determination (e.g., W-2 vs. 1099) including jurisdiction, rulepack hash, factor outcomes, timestamp, and a digital signature.
Proof-of-Netting (PoN): A receipt documenting netting math including gross obligation vectors, offsets applied, exclusions, residuals, and correlation identifiers for payment-rail tracing.
Proof-of-Benefit (PoB): A receipt documenting that specified policy predicates or plan constraints were satisfied and that a quantified benefit or value capture was realized for a participant or group.
Surplus Value: A measured efficiency gain attributable to optimization (e.g., gross-notional reduction, fees avoided, retries avoided, capacity utilization gains).
Hierarchy-of-Needs Allocation: A tiered distribution policy that allocates net receipts first to essential obligations, then to financial-security obligations, and then to discretionary or growth uses, enforcing an order-of-operations per cycle.
Trust Coefficient: A dynamic reliability measure derived from evidence-rich receipts, status events, and settlement behavior, usable to adjust reserves, access tiers, collateral, or pricing.
Ownership Inefficiency Metric: A computed measure of divergence between (i) a predicted most-efficient-use vector output by the AI/ML engine and (ii) an observed or declared use vector for an asset. In embodiments, the predicted most-efficient-use vector is a fixed-length structured object (e.g., a tuple, embedding, or vector) that encodes predicted values, probabilities, and/or expected outcomes for a plurality of candidate use configurations and/or ownership wrappers, such as utilization intensity, lifecycle stage, financing posture, tax posture, risk posture, and expected net benefit under each candidate ownership structure. In embodiments, the metric includes (a) a magnitude term (e.g., L1/L2 distance, cosine distance, or a divergence) and/or (b) an expected benefit delta term (e.g., E[Obj(best_candidate)]−E[Obj(current)] attributable to retitling or reconfiguration).
Transaction-Compression Metric: A computed measure of how much a set of obligations, settlement legs, messages, or intermediated steps is reduced by consolidation, multilateral netting, or internal execution. In embodiments, the metric includes a ratio (gross count ÷net count), a percentage reduction, a reduction in distinct counterparties, and/or a reduction in external API calls or payment-rail legs.
Interaction Surface Metric: A computed measure of external exposure associated with executing a workflow, including the number of distinct external counterparties, credential exchanges, network messages, settlement legs, and/or manual handoffs. In embodiments, interaction-surface reduction is treated as a security and resiliency improvement and is stored in receipts as evidence of reduced attack surface.
Intermediary Internalization/Intermediary Internalization Controller: A control mode and associated module that reduces reliance on external intermediaries (broadly construed to include agents, brokers, managers, clearinghouses, marketplaces, government portals, and other third-party services) by executing equivalent functions within the platform under policy control (e.g., internalizing matching, pricing, underwriting, reconciliation, eligibility determinations, document preparation, and/or settlement preparation). In embodiments, the controller monitors a transaction-compression metric and an interaction-surface metric and transitions a workflow from external execution to internal execution when thresholds, receipts, and rulepacks indicate that internalization will preserve compliance while improving performance, security, cost, and/or resiliency.
Network Interdependence Graph: A directed, weighted graph G=(V,E) representing value flows, obligations, credential portability, and intermediary leakage, where vertices include participants (users, households, employers, plans, vendors, pools, and intermediaries) and edges include normalized flows annotated with attributes such as flow_type, in_network flag, jurisdiction_key, and instrument type.
Interdependence Index (IIndex): A dimensionless scalar computed from the Network Interdependence Graph over a time window to quantify the degree to which value flows are internalized. In one non-limiting implementation, I(t)=w1·R_cross(t)+w2·D_net(t)+w3·P_cred(t)+w4·S_surplus(t), where R_cross is a ratio of cross-entity netting achieved, D_net is a reduction in gross settlement legs, P_cred is a credential-portability score, and S_surplus is a normalized surplus captured by compression and redistributed under a benefit-sharing parameter.
Jurisdictional Parameter Graph (JPG): A versioned, graph-structured representation of jurisdiction-specific constraints and policy nodes (e.g., tax rules, benefit eligibility tests, plan constraints, data residency constraints) used by the rulepack compiler, including effective dates, precedence edges, and proof paths.
Task Compliance DAG: A bounded-degree directed acyclic graph representing task parcels and their compliance dependencies, used in embodiments in which work allocations, labor classifications, and benefit eligibility are optimized as assets.
HybridWorkerState: A time-sorted, non-overlapping interval store keyed by wall-clock time that stores classification labels and usage states, enabling O(log M+C) compliance queries via an interval tree, where M is the number of stored intervals and C is the number of returned intervals.
DeductionPolicy: A structured object bound to a deduction or recoupment event (including benefit advances), including fields {basis, authority, cap, consent_artifact, priority, and minimum_netpay_floor}, used to enforce wage-assignment and deduction limits and net-pay floors during netting/compression.
TransitionReceipt/SunsetRecord: A typed receipt recording an intermediary internalization transition, including prior_state, new_state, index values, key performance indicators, affected flows, and a policy basis for the transition.
Benefit Funding Agreement: A digitally signed consent artifact authorizing plan-adjacent advances and repayments, including caps, repayment schedule rules, revocation behavior, and linkage to eligibility credentials; referenced by benefit-advance receipts.
Data Residency Policy: A rulepack component specifying allowed storage locations and processing regions for a record class or model update, including conditions for cross-border transfer (e.g., transfer only digests/receipts, require trusted execution environments for processing).

### 3. System Architecture

FIG. 1 illustrates an example computing platform that includes at least one computer system with one or more processors and memory storing executable instructions. The platform may be deployed as a cloud service, an on-premises appliance, an edge device, or a hybrid combination thereof. Client devices (e.g., user mobile devices, employer systems, benefit administrator systems, banking systems, broker-dealer systems, and/or auditor systems) may connect to the platform via one or more networks.

In a representative embodiment, the platform comprises the following subsystems, which may be implemented as separate services or modules:
(a) Ingestion and Normalization Service;
(b) Policy Lattice and Rulepack Compiler;
(c) Efficient-Use Prediction Service (AI/ML engine);
(d) Ownership Optimization and Candidate Selection Service;
(e) Execution and Actuation Service (conveyance+usage-right preservation);
(f) Obligation Ledger, Netting Engine, and Settlement Orchestrator;
(g) Receipt Ledger/Event-Sourcing Fabric;
(h) AI Governance Control Plane;
(i) Security, Privacy, and Disclosure-Budget Controller; and
(j) Surplus Metering and Regenerative Routing Module.

### 4. Data Ingestion and Normalization

The ingestion subsystem receives and normalizes data from multiple sources, including user devices, enterprise systems, plan administrators, market data feeds, and third-party service providers. Inputs may include asset profiles, ownership records, utilization telemetry, transaction histories, plan terms, eligibility attributes, and jurisdictional metadata.

In some embodiments, ingestion implements a schema-first pipeline that writes all inputs into typed records with explicit provenance fields (source identifier, timestamp, signature or attestations, and integrity digests). The pipeline may perform validation, de-duplication, unit normalization (e.g., currency, units of measure), and time normalization using a time-fabric module.

### 5. Time Fabric and Period Anchors

In some embodiments, a time-fabric module relabels events into multiple calendar representations (e.g., Gregorian months, 4-4-5 retail periods, 52/53-week fiscal years, ISO weeks) and emits period anchors. Period anchors allow deterministic grouping of obligations and receipts into cycles, smoothing operational peaks and ensuring consistent close and settlement windows.

A period anchor may be recorded as a trusted timestamp token or cryptographic digest over a run manifest for the period, enabling later proof that a given computation was performed with a particular set of inputs at a particular time window.

### 6. Policy Lattice and Rulepack Compiler

Embodiments store and evaluate policy and legal constraints using a versioned rulepack and/or policy lattice. A rulepack may encode jurisdiction-specific tests, factors, thresholds, and effective-date scopes (e.g., labor classification tests, tax limits, plan rules, eligibility requirements, and compliance obligations).

In one implementation, a rulepack record includes:
Header fields: {rulepack_id, jurisdiction_id, effective_start, effective_end, precedence_rank, source_provenance, hash}.
Payload fields: {factor_definitions, thresholds, computation rules, required receipts, exception rules}.
Supersession metadata: pointers to prior versions and any hierarchy relationships (e.g., federal vs. state vs. local precedence).

The policy lattice evaluates constraints as predicates over container records and/or receipts. For example, a policy lattice may gate: (i) whether a re-titling action is allowed for a given asset class; (ii) whether a set-off is legally permitted between two obligations; (iii) whether an ML recommendation is permitted to trigger an actuation without human review; or (iv) whether a disclosure budget permits reveal of certain attributes pre-commit.

In some embodiments, policy changes trigger event-driven recomputation. Instead of recomputing all assets and participants, the system computes an affected-cohort predicate and recomputes only impacted records and receipts.

### 7. Efficient-Use Prediction: AI/ML Categorization Engine

The efficient-use prediction subsystem executes an AI/ML categorization engine over asset-utilization transaction data and related ownership-structure records. The transaction data may include historical business sale transaction information (e.g., sale price, consideration, counterparties, timing, and transaction attributes), lease information, usage telemetry, and user-profile records for a user-asset pair, and may be joined to supplemental datasets of economic outcomes and user demographics. In embodiments, the platform normalizes and canonicalizes the data into a common schema (e.g., time-stamped event records keyed by pseudonymous identifiers), deduplicates records, imputes missing values, derives features (e.g., rolling utilization windows, volatility measures, hazard rates for lifecycle transitions), and binds the resulting feature sets to provenance receipts and data-residency policies. In embodiments, the historical datasets include parameters (features) for each of business sale transaction information, asset usage, ownership structures, and economic outcomes used as inputs to the AI/ML engine.

The AI/ML engine outputs a predicted most-efficient-use vector. The vector may include one or more of: predicted utilization intensity, predicted lifecycle stage transitions, predicted financing posture, predicted tax posture, predicted risk posture, and expected outcome distributions for candidate ownership structures. In embodiments, the vector is encoded as a set of fields (or an embedding) that includes per-candidate scores and confidence values for multiple candidate ownership structures, and may include a distribution (e.g., mean, variance, quantiles) of predicted outcomes; the vector may be accompanied by an explanation object (reason codes) and a proof-carrying predicate set indicating which policy constraints were satisfied in generating the prediction.

The platform compares the predicted vector to declared or observed usage and flags an ownership inefficiency in a data structure (e.g., an OwnershipInefficiencyMetric record keyed by user_id, asset_id, and period_id) when a projected differential meets or exceeds a threshold. The threshold may be configured per asset class and may be adaptive based on volatility, risk budgets, or trust coefficients. In embodiments, the projected differential is computed as a change in an objective function (e.g., Δ=E[Obj(best)]−E[Obj(current)]), optionally normalized by risk or cost, and the threshold may be expressed in absolute units (e.g., dollars of expected after-tax benefit per period) and/or relative units (e.g., percent improvement over baseline) with hysteresis to avoid oscillatory retitling. In embodiments, the evaluate-and-optimize loop invokes re-titling when the projected differential indicates an improvement above a configured re-titling threshold while preserving continuity of use.

### 7.1 Neural-Network Hardware Acceleration (ASIC)

In embodiments, the AI/ML engine executes on an application-specific integrated circuit (ASIC) configured for neural networks and connected to memory storing model weights, activations, and/or training and calibration datasets. The ASIC may include a plurality of neurons organized in an array, wherein each neuron includes a register, a processing element, and one or more inputs, and a plurality of synaptic circuits coupling neurons and including memory for storing synaptic weights. One or more hidden intermediate layers may perform weighted calculations to identify patterns, correlations, and relationships within input data, and may use activation functions such as ReLU and sigmoid to determine non-linear relationships. During training, embodiments use supervised learning in which labeled datasets containing known inputs and desired outputs are fed into the network; a backpropagation algorithm adjusts internal weights to minimize a mean squared error (or other loss) between predictions and actual outcomes; and training iteratively refines predictions until an error rate falls below a predefined threshold, enabling accurate predictions on new, unseen data.

Hardware acceleration can provide practical benefits: (i) reduced latency for inference on edge devices or constrained environments, (ii) reduced energy consumption per inference, and (iii) better throughput for large numbers of assets and participants.

### 7.2 Quantization, Compression, and Memory Footprint Reduction

To reduce storage footprint and memory bandwidth requirements, embodiments store neural-network weights and activations as 32-bit floating-point variables and statically quantize the weights and activations as 8-bit integers. Quantization may be per-layer or per-channel and may include scale and zero-point parameters. By reducing tensor sizes, the platform reduces memory footprint, accelerates cache residency, and improves end-to-end throughput. In embodiments, static quantization includes calibrating scale/zero-point values using a representative calibration set, optionally using symmetric or asymmetric quantization, optionally per-channel quantization for convolutional or fully-connected layers, and packing int8 weights/activations into contiguous memory layouts optimized for SIMD or ASIC multiply-accumulate units. In some embodiments, quantization-aware training is performed to reduce accuracy loss, and a quantization receipt records calibration digests, quantization parameters, and error bounds.

### 7.3 Functionally Invariant Path (fip) Updates and Sparsity Preservation

In some embodiments, the platform executes a functionally invariant path (FIP) algorithm that updates network weights along differential-geometry paths to preserve learned behavior while increasing sparsity. An illustrative update routine can be:
Maintain a calibration set (or replay buffer) representing critical decision regimes.
Constrain weight updates so that model outputs on the calibration set remain within an error envelope.
Apply sparsity-inducing penalties or pruning schedules.
Validate drift and coverage metrics before promotion.
Emit governance receipts binding the model version, training data hashes, and promotion decision.

In one non-limiting implementation, a functionally invariant path update is computed by constraining parameter updates so that the network's outputs on a calibration set remain within a bounded error band while a sparsity objective is improved. For example, the platform can (i) select a calibration batch of representative inputs, (ii) compute a Jacobian or sensitivity of outputs with respect to candidate weight parameters, (iii) compute an update direction that lies in (or is projected toward) a null space or low-sensitivity subspace of the output map, and (iv) apply a step that increases sparsity (e.g., drives selected weights toward zero) while verifying invariance bounds. The platform can record, in a training or governance receipt, the calibration set digest, the bound, and the before/after sparsity and accuracy measures to provide evidence of preserved learned behavior.

In one non-limiting implementation, the FIP algorithm treats the parameter space of the neural network as a manifold and defines a local metric (e.g., based on a Jacobian or Fisher-information approximation) to measure functional change. The FIP update computes a path of weight updates that (i) constrains output deviation on a calibration set to remain within an error bound ε while (ii) optimizing a secondary objective such as sparsity, weight magnitude, or structured pruning. This allows the platform to compress and update models in-place without catastrophic forgetting while maintaining predictable inference behavior. In embodiments, the computed update path approximates a geodesic or other low-functional-change trajectory under the chosen metric (e.g., a natural-gradient or trust-region step), thereby constituting a differential-geometry path in weight space that preserves functional behavior while enabling structured sparsification and compression.

Example FIP update steps (illustrative):
select a calibration set C from stored asset-utilization transaction data and supplemental historical datasets;
compute a local sensitivity metric M (e.g., M≈J^{T}J where J is a Jacobian of outputs with respect to weights evaluated on C);
solve for an update Δw that minimizes a sparsity objective subject to a functional-change constraint Δw^{T}MΔw≤ε²;
apply Δw and optionally prune or zero weights according to a structured sparsity mask; and
emit a model-update receipt binding a model identifier, a rulepack identifier, a calibration-set digest, and an error-bound value used to constrain the update.

### 7.4 Alternative Model Architectures, Compression Methods, and Hardware Variations

In addition to the feed-forward neural network and ASIC execution described above, embodiments may implement the predicted most-efficient-use vector using alternative model architectures selected based on latency, explainability, and evidence requirements. By way of non-limiting examples, the model may be a transformer, a graph neural network (GNN) operating on an obligation/asset graph, a recurrent or temporal-convolution model for spatiotemporal usage prediction, or a reinforcement-learning (RL) policy that selects retitling actions under constraints and observed rewards.

Embodiments may use additional compression and acceleration techniques, alone or in combination with the static 32-bit-to-8-bit quantization described herein. Non-limiting examples include structured pruning (e.g., channel or head pruning), unstructured pruning with sparse matrix encodings, low-rank factorization, weight sharing, entropy coding (e.g., Huffman coding) of quantized weights, mixed-precision quantization (e.g., 4-bit weights with 8-bit activations), and knowledge distillation from a larger teacher model to a smaller deployable student model. Calibration may be performed per-layer or per-channel, and may use representative utilization datasets to maintain accuracy.

Hardware acceleration may be provided by any suitable compute substrate, including but not limited to GPUs, tensor processing units (TPUs), field-programmable gate arrays (FPGAs), network processing units (NPUs), or heterogeneous systems-on-chip (SoCs) that include secure enclaves and direct memory access for receipt spines. In certain implementations, a subset of inference (e.g., threshold checks and candidate ranking) is performed at the edge (e.g., on a mobile device or on-prem appliance) while heavier training and backtesting run in a data center. Receipt artifacts can be generated locally and later anchored to a centralized or distributed ledger.

These variations are disclosed to support enablement and claim flexibility. Unless expressly required by the claims, the invention is not limited to any specific AI model type, compression technique, or hardware implementation.

### 8. Distributed Sharding and Geospatial Migration

Embodiments may store utilization datasets, receipts, and other records across distributed memory devices in multiple geospatial data centers. The system may migrate dataset shards between data centers when a latency-or-cost heuristic is met, sustaining parallel low-latency access. Shard migration can include caching frequently accessed data and prefetching anticipated data to reduce access latency for inference and optimization routines. In some embodiments, shards are addressed using a shard map (e.g., consistent hashing or a versioned placement table) and are replicated across regions according to a data residency policy. Migration can be executed as a copy-then-cutover operation with integrity checks (e.g., hash verification), encryption in transit and at rest, and idempotent replay using receipt identifiers. In some embodiments, the heuristic considers (i) network latency; (ii) compute saturation; (iii) storage cost; (iv) regulatory or contractual locality constraints; and (v) predicted near-term access patterns derived from scheduled events or model-access telemetry.

### 9. Ownership Optimization and Candidate Selection

When an inefficiency is flagged, the platform queries an ownership-entity database to obtain and rank candidate specialized ownership entities. Candidates may include pre-existing entities and/or entities instantiated on demand (e.g., creating an SPV or trust wrapper that meets constraints). In embodiments, each candidate in the database includes a structured attribute record (e.g., jurisdiction, tax classification, eligibility for subsidies or safe harbors, permitted asset classes, governance constraints, cost schedule, and required disclosures) and a readiness state (e.g., pre-vetted, instantiated, or to-be-instantiated).

The platform computes an expected collective economic benefit function across the candidates and selects a top-ranked entity. In embodiments, the objective function is computed over an evaluation horizon and includes at least: (i) expected after-tax net benefit; (ii) expected financing cost and liquidity constraints; (iii) expected risk and loss exposure (including insured and uninsured components); (iv) expected compliance and administrative overhead; and (v) expected transaction compression and reduced-interaction-surface benefits. A non-limiting example objective can be expressed as: maximize Obj(x)=Σ_k w_k·f_k(x)−Σ_m c_m(x) subject to constraints g_j(x)≤0, where x is a candidate ownership wrapper and/or reconfiguration plan, w_k are configured weights or tiered priorities, and constraints are compiled from rulepacks and policy lattice predicates. In some embodiments, the platform records an objective-evaluation receipt that binds (a) the candidate list; (b) the computed score components; (c) the rulepack and model identifiers; and (d) the selected entity.

The objective may be implemented as a multi-objective optimization problem with constraints compiled from rulepacks and policy lattice predicates. In some embodiments, the optimizer produces a Pareto frontier and selects a solution based on configured weights or tiered priorities. In embodiments, constraints include, without limitation: eligibility constraints (e.g., plan participation caps), labor-law constraints (e.g., net-pay floors and consent artifacts), tax-law constraints (e.g., withholding or holding-period rules), data-residency constraints, and governance constraints (e.g., pool quorum rules).

### 9.1 Spatiotemporal, Event-Driven, and Lifecycle-Aware Optimization

In many environments, the most-efficient-use vector is not static. Embodiments therefore model efficiency as a function of time, location, and lifecycle phase. For example, an asset's utilization profile may vary by time-of-day, day-of-week, pay cycle, seasonality, travel patterns, or discrete life events (e.g., hiring, job change, relocation, marriage, childbirth, retirement, vehicle replacement, or housing transactions).

In embodiments, the platform ingests spatiotemporal signals (e.g., geolocation, geofences, device posture, utilization telemetry, commute/usage patterns, service requests, and scheduled commitments) and predicts an efficient trajectory of ownership and usage over a future horizon. The optimizer can therefore schedule retitling events, pre-authorize a settlement window, and migrate relevant dataset shards closer to the compute or settlement venue prior to execution to sustain low-latency access.

In some embodiments, the platform models an end-to-end useful life of a tangible asset (e.g., vehicle, equipment, real property) and uses predicted remaining useful life, maintenance cycles, warranty status, and residual value to choose an ownership wrapper that minimizes total cost of ownership while preserving the user's continuity of access. For example, the platform can (i) retitle a vehicle into a fleet LLC while preserving subscription-style usage rights, (ii) later retitle into a resale SPV, and (iii) later retitle into a nonprofit donation vehicle, each while preserving and reissuing usage agreements and receipts.

Temporal modeling may also be used for compliance and policy optimization. For example, a rulepack may encode annual or monthly thresholds (e.g., W-2 wage bases, contribution caps, Affordable Care Act affordability tests, benefits eligibility cliffs, tax brackets, and plan limits). The platform can simulate alternative schedules (e.g., when to execute a retitling, when to realize a gain, when to shift usage rights) to maximize the objective function while remaining within policy constraints and producing proof-carrying receipts.

### 10. Retitling While Preserving Usage

After selecting a specialized ownership entity, the platform encodes and executes a transaction that transfers legal title of the asset to the entity while preserving usage rights for the user. Encoding may include generating a conveyance record and a usage-agreement record. Execution may be performed via integration with registries, custodians, or internal ledgers depending on asset type. In embodiments, a conveyance record includes fields such as {asset_id, prior_owner_id, new_owner_id, consideration, effective_time, registry_reference, settlement_bundle_id, and signatures}; and a usage-agreement record includes fields such as {usage_right_id, user_id, asset_id, permitted_uses, term, renewal_rules, service_level, revocation_rules, and policy_hash}.

Continuity-of-usage is enforced as an invariant. For example, the platform can:
Maintain stable usage-right identifiers across ownership transitions;
Execute ownership changes within a controlled handoff window;
Use pre-authorized novation clauses or escrow mechanisms;
Dispatch user notifications confirming uninterrupted access. In some embodiments, continuity is implemented using an atomic, two-phase handoff: (1) pre-commit phase that obtains required authorizations, confirms registry/custodian availability, and pre-provisions usage credentials for the new owner; (2) commit phase that executes title transfer and simultaneously activates the usage agreement; and (3) rollback behavior that reverts to prior state if a commit receipt is not emitted within a bounded window. In embodiments, all steps are idempotent using receipt identifiers and exactly-once execution grammar to prevent duplicated transfers.

The platform stores executed conveyance records and executed usage-agreement records (e.g., in a database of assets, ownership entities, and users) and may compute a benefit-sharing parameter that redistributes a portion of measured gains back to the user, a household container, or a pool under governance rules. In embodiments, the benefit-sharing parameter specifies a routing rule (e.g., percentage, cap, priority order) for distributing measured gains among the user, a household container, a pooled vehicle, and/or a regenerative sink, and may be enforced by the policy lattice and recorded in a benefit-distribution receipt.

### 11. Receipt Fabric and Event-sourced Auditability

Embodiments emit typed receipts for key decisions and executions. Receipts can be digitally signed, timestamp anchored, and hash-linked in an append-only event ledger. Receipt chains allow deterministic replay of the platform's operations and stateless verification by auditors, regulators, counterparties, or automated verifiers.

An illustrative receipt header may include:
receipt_type; • receipt_id; • prior_receipt_hash; • timestamp and/or period anchor reference; • input_digests (hashes of key inputs and rulepacks); • output_digests (hashes of key outputs); • signature(s) and signer roles.

Receipt payload fields are type-specific. Examples include:
Proof-of-Classification (PoC): {jurisdiction, rulepack_id, rulepack_hash, factor_outcomes, classification_label, timestamp}.
Proof-of-Netting (PoN): {gross_vectors, offsets, exclusions, residuals, settlement_ids, rail_message_ids}.
Proof-of-Benefit (PoB): {predicate_ids, eligibility_proofs, value_components, computed_benefit, allocations}.
Independence Receipt: {conflict_checks, reroute_actions, approver_roles, mitigation_evidence}.
Risk-Budget Receipt: {risk_caps, timeouts, retry_limits, collateral_requirements, rail_quotas}.
Leakage-Scan Receipt: {scan_scope, detections, redactions, residual_risk}.
RetrievalGuard Receipt: {corpora, freshness_constraints, censor_actions, coverage_metrics}.

### 11.1 Merkle Checkpointing and Stateless Proofs

To enable compact verification, receipts may be periodically checkpointed using Merkle tree roots or other digest schemes. A verifier can validate membership proofs for individual receipts without downloading the full ledger.

### 11.2 Redaction Under Governance

In privacy-sensitive contexts, embodiments may implement controlled redaction mechanisms. For example, the ledger may store immutable headers that commit to payload references, and authorized redactions may update payload references under quorum approval while emitting a redaction proof that is itself immutable. This provides a tamper-evident audit trail of redactions while meeting privacy and retention requirements.

In some embodiments, the platform periodically anchors checkpoint digests (e.g., Merkle roots or other ledger digests) to one or more external trust anchors. External anchoring can include, without limitation: publication to a public blockchain; submission to a trusted timestamp authority; storage in a write-once/read-many (WORM) repository; notarization by an independent service; or cross-posting to a counterparty system. Multi-anchor strategies can reduce reliance on any single operator and can increase tamper resistance.

### 11.3 External Anchoring, Timestamping, and Multi-Anchor Integrity

In some embodiments, bounded verification is enabled by periodic checkpoint receipts (e.g., Merkle roots of a receipt spine) and by retaining only a bounded number of prior receipts needed to validate state, while archiving older receipts to colder storage. Verification can be performed using membership proofs against checkpoint roots, without downloading the full ledger. This provides a concrete improvement to network bandwidth and audit latency.

The platform may implement a materiality predicate layer that determines which portions of an execution are essential to persist for later audit or dispute resolution. For example, instead of storing full PII, the platform can store: (i) a commitment (hash) to original data; (ii) a minimal set of derived features used by the model; and (iii) a proof that the features satisfy applicable constraints. This can reduce storage footprint and limit disclosure while preserving verifiability.

In some embodiments, receipts are proof-carrying in the sense that a receipt includes (or is associated with) a verifiable proof object that allows a verifier to check correctness of a predicate without ingesting all underlying raw data. Examples include Merkle membership proofs, range proofs, linkage proofs, and selective-disclosure proofs derived from verifiable credentials. Proof objects can be stored inline, stored as digests with retrievable proof blobs, or deterministically recomputed from archived artifacts.

### 11.4 Proof-carrying Receipts, Materiality Predicates, and Bounded Verification

In some embodiments, exactly-once semantics are achieved even across heterogeneous subsystems by coupling the receipt grammar to external correlation identifiers and by recording a mapping between internal receipt identifiers and external rail identifiers. For example, a bank-rail message may carry an ISO 20022 EndToEndId and/or a SWIFT UETR, which is stored in receipts. This enables deterministic reconciliation and reduces the need for manual exception processing.

To prevent double-execution, each attempted transition may be tagged with a deterministic execution identifier and/or an idempotency key derived from canonicalized inputs (e.g., period_id, asset_id, participant_id, rulepack_hash, candidate_entity_id, and transaction intent digest). The orchestrator maintains a deduplication index keyed by the idempotency key. If the same idempotency key is encountered again, the platform can (i) decline execution, and (ii) emit a DuplicateReceipt that references the prior receipt, identifies the duplicate attempt, and records the disposition (ignored, flagged, or escalated).

In some embodiments, the receipt ledger is not merely a passive log; it encodes a formal grammar of allowable receipt sequences such that valid state transitions are machine-checkable. For example, a given action (e.g., execute conveyance, authorize a netting set, apply a withholding update, dispatch a settlement group, or publish a rulepack) may be represented as a finite-state transition that consumes an input receipt (or a set of prerequisite receipts) and produces an output receipt. The platform may reject (or quarantine) any attempted transition that does not satisfy prerequisite receipt types, hashes, signatures, or policy gates.

### 11.5 Exactly-Once Receipt Grammar and Idempotent Execution

### 12. Obligation Ledger, Netting, and Settlement Compression

To reduce transaction volume and disintermediate reconciliations, embodiments maintain an obligation ledger that records obligations across categories (payroll, benefits, premiums, taxes, brokerage flows, usage fees, and others). For each period, the netting engine identifies offsetting obligations and forms netting sets subject to legal set-off constraints.

An illustrative netting workflow is:
(a) Collect all obligations for a clearing group for a period.
(b) Build a candidate offset graph where nodes represent obligations and edges represent legally eligible offsets.
(c) Solve for an offset selection that maximizes gross-notional reduction subject to constraints (currency, timing, mutuality, risk budgets).
(d) Produce residual settlement vectors per participant.
(e) Emit a Proof-of-Netting receipt binding gross vectors, offsets, exclusions, and residuals.
(f) Execute residual settlements and bind rail message identifiers into a settlement manifest.

If set-off is barred for an obligation (e.g., due to legal, contractual, or segregation constraints), the platform isolates the obligation and schedules linked gross transactions instead, recording explicit “no-net” reasons in the PoN receipt.

### 12.1 Pre-offset Authorizations and Atomic Execution Groups

In some embodiments, the platform generates a pre-offset authorization bundle that pre-authorizes a set of netted transfers for execution within a defined time window. The bundle may include a nonce, expiry, risk budget, and references to required receipts (e.g., PoC/PoB/AI governance receipts).

For cross-rail execution, the settlement orchestrator may implement atomic groups spanning multiple rails using two-phase commit or comparable protocols, providing payment-versus-payment semantics. Where full atomicity is not possible on a given rail, the platform may implement compensation flows and record them in receipts.

### 12.2 Transaction-Compression Metrics and Intermediary Internalization

In embodiments, the platform computes one or more transaction-compression metrics that quantify consolidation achieved by the obligation ledger and netting engine. For example, the platform can compute: (i) a gross obligation count for a clearing group and period, (ii) a net obligation count after offsets and exclusions are applied, (iii) a number of external settlement legs required to execute net positions, and (iv) a number of distinct external counterparties or intermediaries required. The platform can store these values, along with the gross-to-net math, in a proof-of-netting receipt.

In embodiments, a transaction-compression metric may be expressed as a ratio (gross÷net), a percent reduction ((gross−net)/gross), or a vector including multiple components (e.g., message-count reduction, counterparty-count reduction, credential-exchange reduction, and time-to-finality reduction). The platform can also compute an interaction-surface metric and store the computed values in receipts to provide audit-grade evidence of reduced complexity and reduced attack surface.

To implement disintermediation, embodiments include an intermediary internalization controller that uses one or more transaction-compression metrics and/or interaction-surface metrics as a gating signal. In one embodiment, when a transaction-compression metric meets a threshold (and optionally when governance receipts indicate stable performance and policy compliance), the controller transitions a workflow from external-intermediary execution to platform-internal execution.

Non-limiting examples of intermediaries that may be reduced include agents, brokers, managers, marketplaces, clearinghouses, reconciliation service providers, payment processors, document preparation services, and other third-party services. In embodiments, the controller can internalize functions such as matching, pricing, underwriting, reconciliation, classification/eligibility evaluation (under rulepack control), settlement preparation, and/or execution orchestration, while still producing regulator-grade receipts.

In some embodiments, intermediary internalization is implemented as a progressive migration: early deployments may use external “execution providers,” while the platform records receipts and evidence. As transaction volume grows and receipts demonstrate reliability, the platform can incrementally replace external calls with internal modules (e.g., replace external reconciliation with event-sourced reconciliation, replace external aggregation with internal obligation ledger construction, or replace external matching with internal candidate selection).

In embodiments, intermediary internalization reduces latency and failure modes by reducing external calls, reducing duplicate credential exchanges, and reducing settlement legs. The resulting reduction in interaction surface can be treated as a security improvement and can be included as a component in the collective economic benefit objective.

### 12.3 Graph-Based Netting Algorithms, SCC Decomposition, and Net-Pay Floor Enforcement

In some embodiments, the obligation ledger is represented as a directed weighted graph G=(V,E) in which vertices correspond to participants or accounts and edges correspond to obligations, contributions, premiums, repayments, taxes, fees, or other value flows. Each edge can be annotated with attributes including amount, currency, flow_type, classification_indicator, jurisdiction_key, setoff_eligibility, and plan_boundary flags. The netting engine computes a settlement vector that reduces redundant edges while preserving legally permitted net positions.

In one implementation, the netting engine partitions the obligation graph into strongly connected components (SCCs) (e.g., via Tarjan's algorithm) and performs cycle-cancellation and/or minimum-cost circulation within an SCC to eliminate circular flows. This reduces message count and settlement legs, and reduces the interaction surface available to intermediaries and attackers.

The netting/compression process can be constrained by policy lattice rules. Non-limiting constraints include: (i) excluding edges that cross plan-asset boundaries (e.g., ERISA/plan assets) or that violate setoff rules; (ii) partitioning obligations by classification_indicator (e.g., W-2 vs. 1099), jurisdiction_key, or funding-source constraints; (iii) maintaining traceability by storing both a gross view and a compressed view with mapping receipts; and (iv) generating no-net reason codes when a candidate netting edge is prohibited.

Net-pay floor enforcement: in embodiments involving payroll deductions or benefit-advance recoupment, the platform evaluates candidate settlement vectors against a minimum net-pay floor. A DeductionPolicy object can specify a floor value, priority ordering, and deferral rules. When a candidate net pay falls below the floor, the platform can defer or re-prioritize lower-priority deductions across periods while recording a net-pay-floor enforcement receipt.

### 13. Security, Privacy, and Disclosure Budgets

Embodiments may accept inputs as verifiable credentials (VCs) and may use selective disclosure to prove predicates without revealing raw personally identifiable information (PII). For example, a participant may prove that an eligibility or affordability predicate holds without disclosing salary or precise health plan premium amounts.

Opaque-to-transparent matching embodiments allow supply and demand to match on predicates under disclosure budgets: initial matching uses non-identifying predicates; a commit event forms a binding agreement; and only then are additional attributes revealed per policy. Reveal events are logged as receipts.

In some embodiments, transaction compression (including multilateral netting, consolidation of settlement legs, and atomic execution groups) provides a measurable security improvement by reducing the number of external calls, credentials, and reconciliation touchpoints. Replacing multiple gross transactions with fewer residual settlements reduces messages transmitted over external networks and reduces opportunities for interception or manipulation. The platform may compute an interaction-surface metric and store it in receipts as evidence of attack-surface reduction.

### 13.1 Security Benefits of Transaction Compression and Reduced Interaction Surface

In some embodiments, privacy budgets are explicitly tracked and enforced. A privacy budget can be expressed as a finite resource that is consumed when queries or model actions reveal information about a participant. Each consumption generates a privacy budget receipt that records an amount consumed, a governing policy, and a justification. When a budget is exhausted, the platform denies further disclosure or requires additional authorization. Differential privacy techniques, k-anonymity thresholds, or aggregation constraints may be used as part of budget enforcement.

In some embodiments, participants provide inputs using verifiable credentials and selective disclosure. For example, a participant may prove a predicate (e.g., plan eligibility, income range, age range, or employment status) without disclosing an underlying attribute value. The platform may store only the predicate outcome, a credential issuer identifier, and a proof digest in a receipt, limiting retention of personally identifiable information.

### 13.2 Privacy Engineering: Selective Disclosure, Differential Privacy Budgets, and ZK Predicates

In privacy-sensitive environments, certain records may need to be redacted, corrected, or access-restricted while maintaining tamper-evident auditability. In some embodiments, the platform implements a redactable ledger in which entries are linked using redaction-supporting cryptographic mechanisms (e.g., chameleon hashes or other controlled-collision constructions) and/or by storing redaction maps that preserve a verifiable chain of custody. Redaction authority can be governed via quorum control, and each redaction may generate a redaction receipt that binds the reason, approvers, and the resulting post-redaction digest.

In some embodiments, selective disclosure is implemented using verifiable credentials and selective-disclosure signing formats (e.g., SD-JWT or BBS+-style selective disclosure) so that a participant can prove an attribute (e.g., eligibility, residency, age range, income range, plan enrollment) without revealing underlying personally identifiable information.

In some embodiments, the platform uses zero-knowledge proofs to prove policy predicates (e.g., “contribution within cap,” “household income within a safe harbor,” “licensed in jurisdiction,” or “asset located within permitted geofence”) without disclosing raw data. Predicate-proof identifiers, disclosure budget identifiers, and rulepack hashes can be bound into receipts to preserve auditability while minimizing disclosure.

In some embodiments, privacy-preserving learning techniques are used, including federated learning, secure multiparty computation, and/or differentially private gradient updates, so that model improvements can be learned from distributed shards while enforcing data residency policies and privacy budgets.

### 13.3 Redactable Ledger, Chameleon Hashes, and Governance-controlled Redactions

In some embodiments, the platform detects data poisoning or adversarial manipulation by validating input provenance, checking data distribution drift against baseline receipts, and performing integrity checks on supplemental datasets. Such checks can be recorded in data integrity receipts, providing evidence that the model operated on untampered inputs.

In some embodiments, integrity is enforced using a combination of: digitally signed receipts; hash-linked receipt chains; Merkle checkpoint roots; deterministic serialization of input records; and monotonic counters or nonces bound to state transitions. The platform enforces anti-replay by requiring each action to consume a unique capability token (or unique state receipt) and by rejecting attempts to re-use the same token/receipt. Suspicious replays may be recorded as anomaly receipts for later investigation.

### 13.4 Integrity, Anti-tamper Controls, and Replay Resistance

In some embodiments, the platform supports selective re-wrapping when an ownership reassignment occurs. For example, when legal title transfers from a first entity to a second entity while usage rights remain with a participant, the platform re-wraps a relevant DEK under the second entity's KEK without re-encrypting the underlying ciphertext, and records the re-wrapping event as a receipt. This supports continuity of access while preserving confidentiality.

In some embodiments, executed records, receipts, conveyance records, and usage agreements are protected using encryption and key management mechanisms. The platform may implement envelope encryption, in which a data encryption key (DEK) encrypts a payload and a key encryption key (KEK) wraps the DEK. Keys may be organized hierarchically, for example: (i) a tenant key; (ii) participant or container keys; (iii) asset keys; and (iv) per-period keys. This hierarchy supports rotation, revocation, and compartmentalization.

### 13.5 Cryptographic Key Management and Envelope Encryption

In some embodiments, the platform uses sealed storage such that sensitive secrets (e.g., private keys, model weights, or rulepack signing keys) are accessible only to an attested workload. The platform may use enclave-derived keys to decrypt payloads and to sign receipts. Where model weights are protected, the platform stores a model hash and/or a signed model manifest in a receipt such that any model change is detectable during audit. In embodiments, cryptographic keys are generated and protected using hardware roots of trust (e.g., TPMs, secure elements, or hardware security modules), and key rotation events are recorded as key-rotation receipts that bind prior key identifiers, new key identifiers, effective time, and revocation status. In embodiments, envelopes include key identifiers so that decryptability and auditability are preserved across rotations.

In some embodiments, sensitive computations (e.g., predicted efficiency computation, candidate entity ranking, settlement bundle generation, or policy evaluation) are executed inside an attested compute environment, such as a trusted execution environment (TEE) or other hardware-isolated enclave. The platform performs remote attestation to verify that an expected code and configuration are running, and may store attestation evidence (or a digest thereof) in receipts so that later auditors can confirm integrity of the execution environment.

### 13.6 Attested Compute, Trusted Execution Environments, and Sealed Execution

Capability tokens may be bound to a code identity (e.g., container image digest), a model identity (e.g., model hash), and a policy identity (e.g., rulepack_hash). In some embodiments, a capability token is single-use, and consumption of the token is logged as a receipt to prevent replay. Where a requested action would exceed a risk budget (e.g., privacy budget, settlement risk budget, or model-risk budget), the policy gate denies the request and emits a denial receipt describing the violated constraint.

In some embodiments, the platform enforces a zero-trust posture for both data access and action execution. Rather than granting long-lived credentials or broad permissions, an execution service (e.g., scheduling service, netting service, policy engine, or settlement orchestrator) requests narrowly scoped capabilities from a policy gate at runtime. The policy gate evaluates the requesting workload's identity, integrity evidence, jurisdiction, and current policy state, and issues a short-lived capability token authorizing a specific action on specific records for a bounded time window.

### 13.7 Zero-Trust Execution Membrane and Capability Leasing

### 14. AI Governance Control Plane

In some embodiments, model-influenced decisions are gated by an AI governance control plane that enforces provenance, confidence thresholds, bias/fairness budgets, and jurisdiction-specific automated-decision policies. The control plane may include:
Model provenance tracking (model version identifiers and hashes); • Runtime environment attestations (e.g., secure enclave attestations); • Confidence gates (e.g., conformal-style thresholds); • Drift monitoring and safe-mode downgrades; • Human-in-the-loop checkpoints and override receipts.

In some embodiments, the platform performs security testing and robustness testing for deployed models and services, including adversarial example testing, data poisoning detection, and dependency vulnerability checks. The platform may generate release receipts that include software bills of materials (SBOMs), model artifacts, and security scan digests, enabling later verification of what code and model were deployed at a given time. Subsequent execution receipts may reference these release receipts.

### 14.1 Security Testing, Adversarial Robustness, and SBOM/Release Receipts

In some embodiments, certain classes of actions (e.g., high-value conveyances, changes in withholding, changes in coverage, or large cross-rail settlement groups) require human approval or multi-party approval. Approvals may be recorded as signed approval receipts that are single-use and bound to a specific action intent digest, preventing replay. Overrides can likewise be recorded as override receipts for later audit.

### 14.2 Human-in-the-loop Overrides and Governance Receipts

In some embodiments, continual learning is performed using a functionally invariant path (FIP) algorithm that updates weights along a constrained path that preserves model behavior on a reference set while increasing sparsity, compressibility, or robustness. The platform may record an FIP update receipt including a reference set digest, path constraints, sparsity targets, and before/after model hashes.

In some embodiments, deployed models are monitored for drift, including drift in input distributions, drift in output distributions, and drift in realized outcomes relative to predicted outcomes. The platform may record drift receipts and may place a model into a guarded mode when drift exceeds thresholds. In some embodiments, calibration and/or conformal prediction techniques are used to bound uncertainty, and bounds are stored in receipts to document when an action was taken under bounded risk.

### 14.3 Drift Monitoring, Conformal Bounds, and Continual Learning

In some embodiments, the platform generates a structured explanation artifact for a decision, such as: features relied upon; rules triggered; constraints applied; and an outcome rationale. The explanation artifact may be stored (or stored as a digest) as part of an explanation receipt and can be used to support contestability workflows. In contestability workflows, a participant may submit a challenge, and the platform may perform deterministic replay under the same rulepack and model version (or under a revised rulepack) to evaluate the challenge.

### 14.4 Explainability, Reason Codes, and Contestability

In some embodiments, model-influenced decisions are gated by a governance control plane that enforces provenance, consent, policy compliance, and risk budgets. The control plane may implement configurable control sets mapped to internal policies or external risk frameworks (e.g., the NIST AI Risk Management Framework) and/or to an AI management system standard (e.g., ISO/IEC 42001). The platform may generate control-map receipts binding applied controls to specific model versions, rulepacks, and decision classes.

### 14.5 Governance Guardrails, Risk Controls, and Standards-mapped Control Sets

In some embodiments, the platform emits training and validation receipts that document the training procedure and evaluation results. For example, a training receipt may record supervised learning epochs, acceptance criteria, and a digest of training metrics. A validation receipt may record accuracy metrics, calibration metrics, stability metrics, or constraint-satisfaction metrics for jurisdiction-specific guardrails. These receipts allow later audit to determine whether the platform operated within configured performance bounds.

In some embodiments, the platform treats model artifacts (including weights, quantization parameters, activation clipping parameters, feature transforms, and hyperparameters) as versioned assets that are cryptographically bound to the receipts they influence. A model manifest may include: model_id; model_hash; training_data_digest(s); feature_schema_hash; hyperparameter set; quantization scheme; FIP path identifier; and a signing key identifier. The platform may store a model-manifest receipt (or a digest thereof) so that an auditor can determine which model version influenced a decision.

### 14.6 Model Provenance, Versioning, and Training Receipts

### 15. Surplus Metering and Regenerative Routing

Embodiments may compute surplus value created by optimization and compression, such as fees avoided, gross-to-net reductions, retries avoided, and utilization gains. A savings meter records these measurements and binds them to receipts for the period.

A governed router may allocate surplus under a distribution policy, which can be tiered (hierarchy-of-needs allocation) such that essential obligations are funded first, then security buffers, then growth allocations. Allocation actions may be recorded as surplus receipts linked to the underlying PoN and PoB receipts.

### 16. Vertical Instantiations As Dependent-claim Implementations

The efficient-use kernel can be instantiated across a wide range of domains. The following examples illustrate how domain-specific semantics can be expressed as dependent-claim features while preserving a stable independent-claim core.

### 16.1ESPP/401 (k)/Benefits Autopilot (Plan-Bound Entitlements)

In one embodiment, the asset includes an entitlement to participate in an ESPP and/or a retirement plan match. The platform ingests plan terms and eligibility credentials, predicts an efficient participation configuration, and forms an execution bundle that consolidates payroll deduction legs, brokerage purchase and sell-to-cover legs, tax remittance legs, and employer match legs. Multilateral netting may reduce gross legs, and receipts document compliance with plan limits and value capture.

In embodiments, a plan-bound entitlement is treated as an asset even when the underlying plan rules restrict assignment or transfer. The platform therefore distinguishes (i) the underlying entitlement (e.g., a statutory or plan-defined right, contribution limit, discount, match, subsidy, or eligibility state) from (ii) an ownership wrapper that can be transferred, pledged, or reconfigured without violating the underlying plan rules. The ownership wrapper can represent, for example, a beneficial interest, a secured financing position, a right to receive a portion of a discount or match, or a synthetic exposure that is cash-settled while leaving plan participation unchanged.

For example, in an employee stock purchase plan (ESPP) embodiment, the platform ingests offering terms, contribution caps, enrollment windows, lookback/discount parameters, payroll timing, and participant demographics. The AI/ML engine predicts an efficient participation configuration that maximizes expected after-tax and after-fee benefit while respecting plan constraints. The platform can optionally generate an execution bundle that includes pre-authorized deductions, settlement identifiers, an internal netting plan for offsets, and receipts documenting that plan limits and tax predicates are satisfied.

In a retirement-plan (e.g., 401 (k)) embodiment, the platform models contribution elections, match formulas, vesting schedules, loan limits, and hardship or in-service withdrawal rules. The optimizer can determine whether the participant's short-term liquidity needs are better served by (i) retitling other assets into a lower-cost ownership wrapper (e.g., a subscription-style usage agreement with reduced cash outlays) or (ii) configuring a financing wrapper that advances an amount against future match or planned contributions while keeping the participant's plan contributions within permitted boundaries. Receipts can document compliance with contribution caps and eligibility rules.

In an Affordable Care Act (ACA) and benefits-eligibility embodiment, the platform encodes affordability and eligibility thresholds (e.g., household income measures, safe harbor tests, and coverage tiers) in a rulepack and simulates alternative ownership/usage configurations that reduce coverage disruption. For example, the platform can choose between an employer-sponsored plan, an exchange plan, or a hybrid configuration, and can schedule retitling or income realization events to avoid eligibility cliffs while preserving lawful compliance. The platform stores proof-carrying receipts documenting the applicable tests, inputs, and outcomes used for the recommendation and any executed action.

More generally, where the underlying entitlement cannot be transferred, the platform can “transfer” the entitlement by transferring an ownership wrapper associated with the entitlement (e.g., transferring a beneficial interest in a special-purpose entity that holds the participant's financing position, transferring a receivable interest associated with a discount, or transferring an internal ledger position that is cash-settled), while leaving the participant's plan registration and plan-governed usage unchanged.

In some embodiments, a benefit maximization engine detects missed or suboptimal benefit utilization (e.g., insufficient 401(k) contributions to capture a match, missed ESPP participation windows, or suboptimal HSA/FSA elections) and proposes or executes adjustments subject to plan rules, tax rules, and consent artifacts. The platform can treat plan-bound entitlements as assets in the optimization objective without transferring plan assets by representing (i) legal title constraints, (ii) usage/eligibility constraints, and (iii) economic value exposure separately.

Benefit funding workflows: in certain embodiments, the platform executes a plan-adjacent advance or funding operation (e.g., fronting contributions, smoothing payroll timing mismatches, or enabling cashless participation) that is legally separate from plan assets. The workflow can include generating a Benefit Funding Agreement, emitting a benefit-advance receipt, and scheduling repayment via permitted deductions or netting while enforcing DeductionPolicy constraints and net-pay floors. For example, an ESPP embodiment can use a sell-to-cover style mechanism or a plan-adjacent advance that is repaid from post-purchase proceeds while remaining within plan transfer restrictions.

In some embodiments, intermediary internalization is applied to benefit financing. The platform measures an external-provider dependency (fees, delays, redundant verification steps) and, when thresholds are met, transitions the benefit-funding function from External to Hybrid or Internalized while preserving compliance (e.g., consent, disclosures, and audit receipts) and preserving user experience.

### 16.2 Task-granular W-2/1099 Classification and Actuation

In one embodiment, work is atomized into units of work (taskoids) carrying evidence for classification factors (control, investment, permanence, integration, skill, and profit/loss opportunity). The platform retrieves a jurisdiction-specific rulepack and evaluates the factors to determine a classification label per unit of work. Each decision emits a PoC receipt that binds the rulepack hash and factor outcomes. Downstream actuation routes compensation through W-2 handling (withholdings, benefits attribution) or 1099 handling (gross payment with optional estimated tax set-asides), and netting receipts reference the PoC receipts.

In some embodiments, the platform produces release and security artifacts for compliance automation modules, such as a software bill of materials (SBOM), dependency scan digests, and attestation evidence for deployed services. These artifacts may be referenced by classification and actuation receipts, strengthening integrity and auditability.

In some embodiments, affordability constraints (e.g., Affordable Care Act employer mandate affordability parameters) are represented as versioned parameters in rulepacks. The platform computes safe harbor results (e.g., W-2 wages method, rate-of-pay method, or federal poverty line method) and emits receipts binding the parameters, the computation method, and the resulting affordability determination. Changes in parameters or participant status can trigger incremental recomputation and staging of updated payroll deductions.

In some embodiments, when the platform changes classification state and/or taxable wages, the platform generates and stages electronic filings. For example, the platform can generate payroll delta records, W-2/W-2c records, and information returns for electronic filing systems, and can store an actuation receipt (e.g., ComplianceReceipt or EFileReceipt) that binds the filing schema version, the staged payload digest, and submission identifiers. Such actuation provides concrete machine action beyond optimization and links tax/reporting effects to prior allocation and netting receipts.

In some embodiments, each unit of work has a unique identifier and a normalized descriptor that includes time, scope, role, location, and jurisdiction. The policy lattice evaluates the descriptor against a classification rulepack and emits a Proof-of-Classification (PoC) receipt that binds the rulepack hash, factor outcomes, and classification label. The classification can be used to drive downstream withholding, benefits eligibility, and reporting logic without requiring manual broker or agent intervention.

### 16.3 Sale-leaseback and Lifecycle Retitling (Tangible Assets)

In one embodiment, the asset is a vehicle, equipment, or real property. The platform selects an ownership wrapper (trust, SPV, nonprofit, pooled vehicle) that improves after-tax outcomes and risk posture while preserving usage. As market conditions and rules change, the platform repeats the evaluate-and-optimize loop and can retitle the asset again without interrupting access.

### 16.4 Intermediary Internalization Loop for External Fee Layers

In some embodiments, the platform treats an intermediary layer itself as an optimization target. For a given intermediary-dependent function (e.g., brokerage, agent-assisted renewals, payroll processors, benefit administrators, document preparation, verification services, or fee-collecting service providers), the platform computes an interaction-surface metric and an interdependence index and executes a state machine that transitions the function among {External, Hybrid, Internalized, Retired}.

In one implementation, when a transaction-compression metric and interdependence index exceed thresholds, the platform internalizes discrete steps of the workflow (e.g., eligibility verification, routing, settlement, audit receipt generation) so that the platform performs the step directly using policy-gated automation. A TransitionReceipt documents the migration of responsibilities, enabling enforceable audit trails and enabling downstream systems to verify that automation complied with applicable rules.

This internalization loop supports disintermediation of middlemen broadly defined, including human agents, broker-dealers, management layers, administrative processors, and external verification services, by replacing redundant transactional steps with automated, receipt-backed execution.

### 17. Computing Environment and Implementation Variations

The functions described herein may be implemented by one or more computing devices including processors, volatile and non-volatile memory, storage, network interfaces, and input/output devices. Instructions may be stored on a non-transitory computer-readable medium and executed by the processor(s) to perform the disclosed operations.

The term “module” refers to software, hardware, or a combination thereof. Modules may be combined, subdivided, replaced, or omitted, and functions may be performed in different orders, without departing from the scope of the disclosure.

Although certain embodiments are described with reference to particular regulations, standards, or program rules, the disclosed techniques are not limited to any particular legal regime or standard. Rulepacks and policy lattices allow the system to adapt to changes in law and policy over time by binding decisions to versioned rule definitions and by triggering incremental recomputation when relevant constraints change.

### 17.1 Hardware Acceleration and Model Compression Variations

In some embodiments, the machine learning operations described herein are executed using one or more hardware accelerators including ASICs, graphics processing units (GPUs), tensor processing units (TPUs), field-programmable gate arrays (FPGAs), or neural processing units (NPUs). Model compression may include static or dynamic quantization (e.g., int8, int4), pruning, sparse matrix representations, weight sharing, or distillation to reduce memory footprint and improve throughput while preserving functional behavior within specified error bounds.

### 17.2 Distributed Storage, Sharding, and Migration Variations

In some embodiments, distributed data storage uses sharding across data centers using consistent hashing and can be migrated based on predicted access patterns, latency, or jurisdictional constraints. Data Residency Policies can bind record classes or model-update artifacts to permitted regions, and cross-border transfers can be limited to digests, receipts, or privacy-preserving aggregates. In some embodiments, processing of sensitive shards occurs within trusted execution environments and only signed receipts cross trust boundaries.

### 17.3 Cross-Rail Integration and Atomic Execution Variations

In some embodiments, external system integration is performed using adapters for settlement rails and registries, with idempotency keys, correlation identifiers, and exactly-once semantics to prevent duplicate execution. For example, payment rail adapters can propagate end-to-end identifiers, unique end-to-end transaction references, or ISO 20022 field values and can emit receipts that bind an external execution identifier to an internal transaction manifest. Atomic execution groups can coordinate multi-leg settlement so that partial execution is detected and remediated using compensating actions and receipt-backed reconciliation.

### 17.4 Event-sourced Implementations and Deterministic Replay Variations

In some embodiments, the platform is implemented as an event-sourced architecture in which state (e.g., current ownership assignments, rulepack versions, eligibility states, and settlement positions) is derived from an append-only log of events and receipts. Deterministic replay can be supported by persisting inputs, model artifact identifiers, policy hashes, and idempotency keys in typed receipts, enabling reconstruction of decisions for audit, dispute resolution, and compliance. Checkpoints and Merkle-root anchors may be used to provide tamper-evident integrity for the receipt spine.

### 17.5 Edge Devices, Sensors, and Physical Implementations

In some embodiments, portions of the platform are implemented in physical or edge devices to support low-latency verification of usage rights, offline operation, and secure key handling. Non-limiting examples include mobile devices, point-of-sale terminals, kiosks, vehicle telematics units, smart locks, building access controllers, and on-premises appliances deployed in an enterprise network.

In embodiments involving tangible assets (e.g., vehicles, equipment, real property), sensors or telemetry feeds can provide evidence of utilization, condition, and location. For example, a vehicle telematics unit can report mileage and usage intervals; a smart lock can log entry events; an equipment controller can report operating hours. These signals can be ingested by the platform and bound into receipts to support proof-of-use, proof-of-condition, and continuity-of-usage assertions.

In certain embodiments, an edge device enforces usage rights by verifying a usage token or capability lease issued by the platform. The token may be time-bounded, location-bounded, single-use, and/or bound to a device identity via attestation. The edge device can also create a local receipt (e.g., a signed event) and later synchronize it to the receipt ledger, enabling eventual consistency while maintaining auditability.

To support security and technical improvements, embodiments may use hardware roots of trust (e.g., TPMs, secure elements, hardware security modules, or enclave-backed keys) to protect cryptographic material used for receipts and settlement bundles. In some embodiments, remote attestation evidence is included in the receipt fabric so that downstream verifiers can confirm that the platform executed within an expected code and configuration.

These physical embodiments are optional and are disclosed as examples of practical implementations that improve reliability, security, and latency for AI-driven ownership allocation and retitling workflows.

1. A system for allocating asset ownership for maximized collective economic benefit, the system comprising:
at least one computer system comprising a processor and a memory storing executable instructions, wherein the processor executes the instructions to:
receive information about a user and an asset used or to be used by the user;
store neural-network weights as a 32-bit floating-point variable;
store neural-network activations as a 32-bit floating-point variable;
statically quantize neural-network weights and neural-network activations as 8-bit integers, wherein the neural-network weights are quantized to reduce storage footprint;
ingest asset-utilization transaction data containing historical sale, lease, usage and user-profile records for the user-asset pair; and
retrieve supplemental historical datasets of economic outcomes and user demographics;
utilize an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and
circuitry operable to execute a functionally invariant path (FIP) algorithm that updates network weights along differential-geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
wherein the ASIC is further configured to:
execute a artificial intelligence machine learning categorization engine on the asset-utilization transaction data and output a predicted most-efficient-use vector for the asset;
compare the ASIC output to the user's declared or observed usage pattern and flag in the data structure a projected differential meeting or exceeding a predefined threshold ownership inefficiency;
issue a query to an ownership-entity database and return a ranked candidate list of specialized entities;
compute the maximum function output value of expected collective economic benefit across the candidate list and select the top-ranked entity;
encode a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; and
wherein the memory further stores instructions that cause the system to:
migrate dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency;
repeat, using the ASIC, an evaluate and optimize process to detect that re-titling of an asset would deliver an improvement above a set threshold and invoke another title-transfer routine that assigns the asset to a newly selected entity without interrupting user access;
apply the FIP algorithm to newly accumulated asset-utilization transaction data so as to refine prediction accuracy while preserving prior knowledge; and
dispatch an electronic alert to the user confirming continuity of usage following an ownership reassignment.

2. The system of claim 1, wherein the asset comprises at least one of: (i) real property; (ii) a vehicle; (iii) equipment; (iv) a financial account or right to cash flow; (v) a plan-bound entitlement comprising an employee stock purchase plan entitlement, a retirement-plan entitlement, or an insurance-benefit entitlement; (vi) compute, storage, or network capacity; or (vii) a subscription or service-access right.

3. The system of claim 1, wherein the specialized entities comprise at least one of: (i) a trust; (ii) a special purpose vehicle; (iii) a cooperative or nonprofit-controlled entity; (iv) an employer-sponsored plan vehicle; (v) a captive cell or pooled reserve entity; or (vi) an escrow, custodial, or secured holding entity that separates legal title from usage rights.

4. The system of claim 1, wherein the benefit-sharing parameter is computed to allocate at least a portion of a measured surplus created by (i) ownership reassignment, (ii) transaction compression, and/or (iii) intermediary internalization, and wherein the system stores a distribution policy that routes the portion of the measured surplus to at least one of the user, a household account, an employer pool, a cooperative pool, or a philanthropic or regenerative allocation account.

5. The system of claim 1, further comprising a receipt ledger configured to store typed, hash-linked, digitally signed receipts that bind (i) normalized inputs, (ii) rulepack identifiers and policy hash values, (iii) model artifact identifiers, (iv) idempotency keys, and (v) execution identifiers to the predicted most-efficient-use vector, the selected specialized entity, and the executed conveyance and usage-agreement records, wherein batches of receipts are Merkle-hashed and a Merkle root is periodically anchored to provide tamper-evident auditability and deterministic replay.

6. The system of claim 5, wherein the system is configured to compute a transaction-compression settlement vector by: (i) representing an obligation ledger as a directed weighted graph having edges annotated with at least amount, currency, flow_type, classification_indicator, and jurisdiction_key; (ii) partitioning the graph into strongly connected components and performing cycle-cancellation or minimum-cost circulation within a component to remove redundant edges while preserving net positions; (iii) excluding, from netting, edges that violate setoff or plan-asset boundaries and recording no-net reason codes in a netting receipt; and (iv) enforcing, using a DeductionPolicy object, a minimum net-pay floor by deferring or re-prioritizing deductions when a candidate net pay falls below a threshold.

7. The system of claim 6, wherein the settlement vector specifies, for each residual settlement leg, a selected settlement rail and a correlation identifier, and wherein the correlation identifier includes at least one of an end-to-end identifier, a unique end-to-end transaction reference, or an ISO 20022 field value propagated through rail adapters.

8. The system of claim 5, further comprising a policy lattice comprising a jurisdictional parameter graph and a rulepack compiler that generates a versioned rulepack used for gating ownership reassignment, transaction compression, and benefit funding workflows, wherein each gated operation is bound to (i) an effective-date interval, (ii) a rulepack version hash, and (iii) an ordered proof path of invoked rule nodes stored in the receipt ledger.

9. The system of claim 5, wherein the system is configured to reduce disclosure of personally identifiable information by using at least one of: (i) verifiable credentials with selective disclosure; (ii) zero-knowledge proofs that prove a policy predicate without revealing underlying facts; or (iii) differential-privacy budgets applied to cohort queries and model updates, and wherein the receipt ledger stores a disclosure budget identifier and a predicate-proof identifier associated with the operation.

10. The system of claim 5, further comprising an intermediary internalization controller configured to: (i) maintain, for an intermediary-dependent function, an internalization state selected from {External, Hybrid, Internalized, Retired}; (ii) compute, from a Network Interdependence Graph, an interdependence index value over a time window; (iii) compare the interdependence index value and intermediary key performance indicators to an internalization threshold; and (iv) when the threshold is met, transition the function to a more-internalized state and emit, to the receipt ledger, a TransitionReceipt that records the prior state, new state, index values, and affected flows.

11. A computer-implemented method for allocating asset ownership for maximized collective economic benefit while preserving usage rights, the method comprising:
receiving information about a user and an asset used or to be used by the user;
storing neural-network weights as a 32-bit floating-point variable;
storing neural-network activations as a 32-bit floating-point variable;
statically quantizing neural-network weights and neural-network activations as 8-bit integers, wherein the neural-network weights are quantized to reduce storage footprint;
ingesting asset-utilization transaction data containing historical sale, lease, usage and user-profile records for the user-asset pair;
retrieving supplemental historical datasets of economic outcomes and user demographics;
utilizing an application-specific integrated circuit (ASIC) for an artificial neural network connected to memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential-geometry paths so as to preserve learned behavior while increasing sparsity;
wherein the array is configured to analyze business sale transaction information, asset usage, ownership structures, and economic outcomes, trained on historical datasets including a parameter for each of business sale transaction information, asset usage, ownership structures, and economic outcomes;
during a training process, training the artificial neural network using supervised learning where labeled datasets containing known inputs and desired outputs are fed into the artificial neural network; adjusting internal weights using a backpropagation algorithm, which minimizes the difference between the artificial neural network's predictions and actual outcomes as measured by a mean squared error loss function; and iteratively refining predictions until an error rate falls below a predefined threshold to enable accurate predictions on new, unseen data;
executing, using the ASIC, an artificial intelligence machine learning categorization engine on the asset-utilization transaction data and outputting a predicted most-efficient-use vector for the asset; comparing the ASIC output to the user's declared or observed usage pattern and flagging in a data structure a projected differential meeting or exceeding a predefined threshold ownership inefficiency; issuing a query to an ownership-entity database and receiving a ranked candidate list of specialized entities; computing the maximum function output value of expected collective economic benefit across the candidate list and selecting a top-ranked entity; encoding a parameter for a transaction execution that transfers legal title to the selected entity while preserving usage rights for the user, wherein encoding comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; migrating dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency; repeating, using the ASIC, an evaluate and optimize process to detect that re-titling of the asset would deliver an improvement above a set threshold and invoking another title-transfer routine that assigns the asset to a newly selected entity without interrupting user access;
applying the FIP algorithm to newly accumulated asset-utilization transaction data so as to refine prediction accuracy while preserving prior knowledge; and dispatching an electronic alert to the user confirming continuity of usage following an ownership reassignment.

12. The method of claim 11, wherein the asset comprises at least one of real property, a vehicle, equipment, a financial account, a plan-bound entitlement, compute capacity, or a subscription right.

13. The method of claim 11, wherein the specialized entities comprise at least one of a trust, special purpose vehicle, cooperative, nonprofit-controlled entity, employer-sponsored plan vehicle, captive cell, or escrow or custodial entity.

14. The method of claim 11, further comprising storing, in a receipt ledger, typed, hash-linked, digitally signed receipts that bind inputs, rulepack hashes, model identifiers, idempotency keys, and execution identifiers to the predicted vector, selected entity, and executed records, and anchoring batches of receipts via a Merkle root.

15. The method of claim 14, further comprising computing a transaction-compression settlement vector using strongly connected component decomposition and cycle-cancellation or minimum-cost circulation, and enforcing a net-pay floor using DeductionPolicy objects, with no-net reason codes stored in netting receipts.

16. The method of claim 11, further comprising gating at least one of the retitling transaction, a benefit funding workflow, or a netting operation using a policy lattice rulepack having an effective-date interval and a rulepack version hash.

17. The method of claim 11, further comprising executing an intermediary internalization controller that transitions an intermediary-dependent function among {External, Hybrid, Internalized, Retired} states based on an interdependence index computed from a Network Interdependence Graph, and storing a TransitionReceipt documenting the transition.

18. A non-transitory computer-readable medium storing instructions that, when executed by one or more processors, cause performance of the method of claim 11.

19. The non-transitory computer-readable medium of claim 18, wherein the instructions further cause storing and verifying typed, hash-linked receipts in a receipt ledger using Merkle-anchored batches and deterministic replay.

20. The non-transitory computer-readable medium of claim 18, wherein the instructions further cause computing a policy-constrained settlement vector by multilateral netting of obligations represented as a graph and emitting netting receipts with no-net reason codes and net-pay floor enforcement records.
